(19) United States
(12) Patent Application Publication
(10) Pub. No.: US 2023/0093550 A1
(43) Pub. Date: Mar. 23, 2023

(54) DISTRIBUTION SYSTEM

(71) Applicant: Roche Diagnostics Operations, Inc., Indianapolis, IN (US)

(72) Inventors: Edwin Oosterbroek, Cham (CH); Nicolas Seungoon Sillitoe, Allenwinden (CH)

(73) Assignee: Roche Diagnostics Operations, Inc., Indianapolis, IN (US)

(21) Appl. No.: 18/052,457

(22) Filed: Nov. 3, 2022

Related U.S. Application Data
(63) Continuation of application No. PCT/EP2021/062252, filed on May 10, 2021.

(30) Foreign Application Priority Data
May 11, 2020 (EP) 20173834.1

(51) Int. Cl. G01N 35/00

(52) U.S. Cl. CPC G01N 35/0092; G01N 35/00623; G01N 2035/00643

(57) ABSTRACT

A distribution system comprising a transport plane for distributing objects and carriers for transporting the objects. A drive system moves the carriers on the transport plane. A control system of the distribution system is configured to control the carriers to move on a planned route from a start position to a final destination position on the transport plane. The control system comprises a routing system configured to calculate the planned route for at least two carriers on the transport plane by modeling the transport plane with nodes and graphs and using a windowed hierarchical cooperative informed search algorithm. The routing system is configured to determine reserved and free time windows for each node. The routing system is configured to assign an individual reservation length to each carrier for the next move on free time windows and assigns an infinite reservation time to the node of a logical position.

### CROSS-REFERENCE TO RELATED APPLICATIONS

This application is a continuation of International Patent Application No. PCT/EP2021/062252, filed 10 May 2021, which claims prioriry to European Patent Application No. 20173834.1, filed 11 May 2020, the disclosures of which are hereby incorporated by reference in their entirety.

### TECHNICAL FIELD

The present disclosure relates to systems, methods and devices for controlling movement of carriers to transport sample containers, in particular tubes, filled with a biological fluid to be analyzed, reagents, cassettes filled with reagents, specimen slides, tissue material, waste, or disposables like pipette tips, tube caps or empty tubes for aliquoting in diagnostics laboratories. The system, methods and devices can also be applied to controlling movements of carriers, which can transport payloads such as goods, wares of a warehouse, products to be manufactured in a manufacturing site, or other objects on a transport plane.

### BACKGROUND

Laboratory diagnostics distribution systems are described in, e.g., EP 3 095 739 A1 or WO2012/158541. These publications describe laboratory sample distribution systems with passive carriers or self-propelling carriers on transport planes.

For instance, WO 2008/148513 describes a storage or conveying system comprising an electromagnetic planar motor which moves one or more conveying devices, especially movable pallets, cars, or containers mounted on wheels or rolls.

WO 2017/186825 describes a robotic load handler coordination system which comprises a robotic load handler capable of traversing, when in use, a plurality of cells arranged in a grid formation.

Routing algorithms to be used in routing systems are also known in the art. “Cooperative pathfinding” (Silver, D., 2005, “Cooperative pathfinding”, Young, R. M., and Laird, J. E., eds., AIIDE, 117-122. AAA I Press) discloses algorithms solving the so-called multi-agent path finding problem, where agents need to find routes to separate destinations, given full information about the routes of other agents. The algorithms are suitable for use in Real-Time Strategy games and other real-time environments. The algorithms proposed assume that a grid represents space, and use the so-called Manhattan distance as the basis for calculating a cost function. They use a windowed search with a limited fixed cooperative search depth called a Windowed Hierarchical Cooperative A* (WHCA*). Also the drawback of these algorithms is described. Certain classes of problems cannot be solved by decoupled, greedy algorithms that precalculate the optimal path, meaning that these problems will end up in infinite computational loops.

B. Zahy et al., “Conflict-Oriented Windowed Hierarchical Cooperative A”, 2014 IEEE International Conference on Robotics and Automation (ICRA), IEEE, May 31, 2014, pages 3743-3748, XP03265061 8, DOI: 10.1 109/ICRA.2014.6907401 describes Multi-Agent Path Finding problem (MAPF) when given a map and a set of agents with distinct source and goal locations. MAPF solvers can be divided into classes based on their purpose. One of these classes is the class of online MAPF algorithms, in which the search for paths is interleaved with the actual physical moves of the agents. A prominent algorithm in this class is the Windowed Hierarchical Cooperative A* algorithm (WHCA*) where paths are planned for each agent individually and cooperation is obtained using a reservation table.

### SUMMARY

Although the embodiments of the present disclosure are not limited to specific advantages or functionality, it is noted that in accordance with the present disclosure a distribution system, a method to control a distribution system and devices to realize a distribution system are provided that enable an improved, more efficient and reliable transport within the distribution system.

In accordance with one embodiment of the present disclosure, a distribution system is provided comprising: a transport plane comprising logical positions for distributing objects, carriers for transporting the objects, a drive system to move the carriers on the transport plane between the logical positions, a control system configured to control the carriers to move on a planned route from a start position to a final destination position on the transport plane, wherein the control system comprises a routing system configured to calculate the planned route for at least two carriers on the transport plane by modeling the transport plane with graphs of nodes and using a windowed hierarchical cooperative informed search algorithm within cooperative time window T, wherein the windowed hierarchical cooperative informed search algorithm is a windowed hierarchical cooperative A* algorithm, wherein the routing system is configured to determine reserved and free time windows for each logical position, characterized in that the routing system is configured to assign an individual reservation length to each carrier for the next move on logical positions with free time windows, wherein an infinite reservation time is assigned to a logical position on the transport plane, wherein the control system comprises at least one executing unit configured for executing the planned routes for transporting the carriers from their respective start position to their respective final position.

These and other features and advantages of the embodiments of the present disclosure will be more fully understood from the following detailed description taken together with the accompanying claims. It is noted that the scope of the claims is defined by the recitations therein and not by the specific discussions of features and advantages set forth in the present description.

### BRIEF DESCRIPTION OF THE DRAWINGS

The following detailed description of the embodiments of the present description can be best understood when read in conjunction with the following drawings, where like structure is indicated with like reference numerals and in which:

FIG. 1 shows a schematic perspective view of a distribution system;

FIG. 2A shows a time-velocity diagram of a carrier moving on a transport plane of the distribution system;

FIG. 2B shows a time-velocity diagram of three possibilities how to parametrize the movement shown in FIG. 2A;

FIG. 3A shows a time-velocity diagram with a real movement and its parametrization;

FIG. 3B shows a time-velocity diagram of the movement shown in FIG. 3A with another parametrization of the movement;

FIG. 4 shows schematics of a reservation length distribution;

FIG. 5 shows two different reservation tables and the corresponding portion of a transport plane with the moves carried out;

FIG. 6A shows two examples of dead-lock situations on a transport plane;

FIG. 6B shows how random moves can resolve the dead-lock;

FIG. 6C shows how subsequent routing can resolve the dead-lock;

FIG. 7 shows schematically the communication connection of an embodiment of the distribution system;

FIG. 8 represents a flow diagram of how the next routes are calculated and executed;

FIGS. 9A, 9B, and 9C represent different transport system area layouts and how to release reserved fields;

FIGS. 10A and 10B compare a route of a carrier on a transport system layout with all logical positions available in comparison to the same layout with blocked logical positions;

FIG. 11 shows an embodiment of a distribution system;

FIG. 12 shows a Gantt diagram;

FIG. 13 shows stochastic effects of movement in routing;

FIG. 14 shows consequences for moves of stochastic effects;

FIG. 15 shows discrete time WHCA* algorithms in gaming vs continuous WHCA* algorithm; and

FIG. 16 illustrates potential moves.

Skilled artisans appreciate that elements in the figures are illustrated for simplicity and clarity and have not been drawn to scale. For example, dimensions of some of the elements in the figures may be exaggerated relative to other elements to help improve understanding of the embodiment(s) of the present disclosure.

### DETAILED DESCRIPTION

A carrier is a support structure to support and transport a payload. The carriers are in particular provided with appropriate holding means to support, and if required, to secure the objects in the needed manner and orientation. The carrier can be self-propelling or can be propelled by and moved on a transport plane.

The transport plane is any kind of two dimensional plane, surface, bed, layer, platform or flat base onto which carriers are positioned such that the carriers are movable in at least two dimensions along the plane. For instance, the transport plane could be a sliding surface mounted in a diagnostics lab or the ground of a manufacturing site or inside a manufacturing hall. Transport planes can be installed vertically or horizontally including slopes. Also curved transport planes are possible. A carrier can contact the surface such that friction can be used to drive and control the movements or a carrier can move contactless, e.g., by air or magnetic levitation providing a small gap between carrier and the surface. For a third dimension either the plane is formed correspondingly with corresponding limitations in upward and downward slope, or some kind of levitation mechanism is installed such as magnetic levitation or air cushion technique with the corresponding limitations in reachable height without losing control. For vertical transportation in the third dimension also elevator/paternoster mechanism can be installed.

A drive system moves the carriers on the transport plane. The drive system can be implemented in the carriers itself, e.g., wheels connected to an electric motor with connected battery and electronics. Another possibility are linear motors. Also possible are passive carriers. For instance, a magnetic device is fixed in the carrier and a magnetic force provided by magnetically active and drivable elements such as electro-magnetic coils, enforcing the carriers to move by generated electro-magnetic fields. The coils can be installed under, above, besides or in the transport plane. For instance, an arrangement of magnetic coils underneath the transport plane is described, e.g., in EP 2 566 787 or WO 2013/098202.

A logical position is defined on the transport plane as a position at which the carrier can stop, start and/or change direction. In systems such as described in EP 2 566 787 or WO 2013/098202 the drive system defines these logical positions by its hardware limitations. In these systems, usually logical positions are defined above an electro-magnetic coil. At these positions it is possible to stop the carrier and to change its direction with the next move. On other transport planes the logical positions can be defined as wanted or required to form a useful set of crossing points, junctions, start and stop positions. The logical position may be an imaginary position in the routing algorithm and/or a position on the real transport system. The logical position may be a discrete position where the carrier can stop. In particular, the logical position may be defined by at least one physical entity of the drive system such as an electromagnetic coil or a crossing of possible ways such as rails.

A logical position can be any position reachable by the passive carriers or any position where the carriers can change direction, be parked or can be identified by an identification or registration system. Identification and registration systems can be a camera system or optical sensors and scanners identifying any optical signature on the carriers or object such as its size, its type, or a bar code. Alternatively or in addition, a RFID-reader system reading a unique RFID of the carrier or object on the carrier or sensors inside the transport plane can be used to identify logical positions and to localize the carriers. A further option can be high precision GPS in particular enhanced with Wi-Fi and or GSM signals.

For routing systems with a partially stochastic behavior, meaning that the carriers do not always move with the same velocity profiles (variation in acceleration, deceleration or constant velocity), planning too far ahead into the future increases the computation effort and the risk of routes being prone to fail. Additionally, new orders for transporting carriers from a starting position to a final destination position will be received, while executing of routes of the other carriers is still ongoing. Accordingly, to increase efficiency of the routing system, the number of moves for a plan ahead in time can be limited. In addition computation times no longer scale with the size of the transport system. The maximum time the router plans ahead is called the cooperative search window of time length T.

For each logical position, time windows are defined at which the position's status is either reserved for potential movements of a carrier or free. If a time window is free, it can be used to plan a move of a carrier during the corresponding time. So, for each logical position a time sequence of individual free and reserved time windows with individual durations is defined. These durations of the time windows are individual and continuous in the sense that the time durations of the windows of each logical position can be individually planned and their values are not a multitude of discrete time steps but a freely definable value. Hence, continuous time durations are defined in contrast to the usual known in the art discretized time windows.

A routing algorithm is an algorithm calculating a route for each carrier on the transport plane from a start position to an intermediate destination position towards a final destination position.

The start position is a logical position where the carrier stands on the transport plane when the algorithm starts calculating the route.

The final destination position is a logical position on the transport plane where the carrier needs to go to. Final destination positions are logical positions on the transport plane which have in particular a special functionality, e.g., where a sample tube, a part of the sample, or a consumable is handed over from or to the transport plane to or from, e.g., an analyzer or pre- or post-analytical system or storage system. For a manufacturing site a final destination position are in particular a logical position corresponding to a machine station performing some manufacturing process on a semi-finished good. A start position for one carrier can also be in particular a final destination position for another carrier or more in particular for the same carrier.

The routing algorithm usually calculates several straight moves for each route starting with the current position of the carrier on a logical position as a starting position to the intermediate destination position. The intermediate destination position is also a logical position. Each move has a start and a stop on a logical position. The stop of a last move of a route is either an intermediate destination or a final destination.

A node is defined as a logical position together with the time window information (reserved or free) used by the windowed hierarchical cooperative search algorithm. A graph is the construct of nodes and the possible connections between them, used by the windowed hierarchical cooperative search algorithm.

Usually the distribution system comprise 2 parts:
A transport system that executes the moves of the carriers as well as possible according to given routes, computed by the router software. The transport system communicates to the control system all or pre-defined position changes of the carriers and potential errors of the transport system.
The software system receives the status updates about the carrier's positions on the logical positions and errors and calculates new routes with next moves, based on this status update and the new requests for transporting carriers to their final destination positions. These moves are sent to the transport system to be executed.

If problems occur with the distribution system the plan may not be executable because, e.g., positions are not accessible or plans may be delayed when the execution of a move takes longer than planned. In both situations the execution of the plan is defined as “failed”.

The windowed hierarchical cooperative informed search algorithm is an informed search algorithm such as A* or D* searching algorithm. For each carrier with a final destination the search algorithm calculates a route from the start position to an intermediate destination position on nodes within the cooperative search window of time length T towards their respective final destination position. The search is cooperative because the route can only pass on free time windows of logical positions. For the logical positions with free time windows needed the required duration of the free time window will change from “free” to “reserved” for the required time slot of the respective logical positions. So the free time window will be split into a reserved time window and one or two further free time windows. The search is hence cooperative for the cooperative time window T by respecting the reserved time windows for other carriers of the logical positions.

The routing system is configured for calculating the planned route using a windowed hierarchical cooperative informed search algorithm within cooperative time window T. The windowed hierarchical cooperative informed search algorithm may be designed for reserving time windows in continuous time and based on a realistic time travel model. The realistic time travel model may be an approximation. The realistic time travel model may be configured such that practically all moves can be executed within a planned time, in particular without wasting time due to reserving too much time. Information for the realistic time travel model may be obtained from measurements on the real system. The realistic time travel model may comprise considering optimistic and/or pessimistic travel times. Optimistic and pessimistic travel time models refer to models that predict an earlier, respectively later arrival than reality. The realistic time travel model may comprise considering a constant acceleration, deceleration and plateau velocity. The model parameters for these may be measured. For small movements of only a few positions the plateau speed may not be reached, such that there may be only an acceleration and deceleration. The model parameters may be chosen from measurements, hence realistic values. The model parameters may be adjusted to become pessimistic. This may ensure that practically always sufficient time is reserved to carry out the moves completely. The model parameters may be adjusted to plan even more time for the moves. The model parameters may be automatically adjusted. The model parameters may be automatically adjusted if too many plans fail due to insufficient time or too often too much time is reserved, which would result in that a carrier has to wait between moves for too long. For example, if short moves fail the acceleration and deceleration may be modified. For example, if long moves fail the maximum velocity may be adjusted to a lower value. For example, the model parameters may be automatically adjusted if a number of moves that follow the plan is 99%. The model parameters may be automatically adjusted by assessing one position moves and/or longer position moves. For example, in cases where acceleration and deceleration are fast enough that even one position moves are affected by the top speed, even one position moves may be assessed. If such moves are often later than the pessimistic estimation, or earlier than the optimistic estimation, the router may adjust the top speed. Specifically, the routing system is configured for calculating a planned route using a windowed hierarchical cooperative informed search algorithm within cooperative time window T considering continuous time duration. In contrast, the known windowed hierarchical cooperative informed search algorithm may reserve time windows by using discrete times. Accordingly, the present disclosure proposes using a modified version of Windowed Hierarchical Cooperative A* (WHCA*) algorithm, denoted continuous WHCA* herein. Continuous time durations may allow the algorithm to be more efficient as the moves can start at any time since the transport system does not use discrete time frames for operation. In addition, considering continuous time durations allow reducing computational needs. In case of state of art discretized times, the discretized times are stored in a fine-grained manner, e.g., 10 ms, a 2 s move becomes 200 segments of time. In memory this may lead to storage of huge arrays of tiny intervals of time. The use of continuous time durations may avoid roughly discretizing, over-reserving and wasting time. The routing system is used for real transport systems, facing deterministic or partially stochastic move speeds. If stochastic effects are present, the times required for each move may not be predicted exactly. The routing system may be configured for reserving time windows based on realistic travel time models. In contrast, known WHCA* are deterministic such that stochasticity cannot be modelled. Thus, the continuous WHCA* algorithm may allow for routing of processes with a partially stochastic time behavior, by modelling optimistic and pessimistic arrival times into each time window, in such a way that most or all of the real moves, including stochastic variations, will take place within these two estimations. This may allow for planning the optimistic-case start and pessimistic-case end of following moves accordingly.

The continuous WHCA* algorithm may be designed for planning a path for each carrier individually, wherein cooperation may be obtained using a reservation table. The routing system is configured for assigning infinite reservation time to a logical position on the transport plane. The use of infinite time windows may ensure that the reservation table is always conflict-free. Conflict-free may refer to that no collisions will occur as a logical position is assigned to maximum one carrier at the same time. The continuous WHCA* algorithm may be designed such that all partial paths may end with infinite reservations to ensure that all carriers have a conflict-free path in space time at any time.

The continuous WHCA* may be designed for planning routes of carriers, with optimal start times for each carrier independently. In contrast with discrete times, this may allow for avoiding computational spikes as starting the movements does not need to take place at discrete times, potentially causing multiple carriers to start at the same time.

The continuous WHCA* may be suitable for providing the routes to transport systems, like sample transport systems in in-vitro diagnostics labs, in an efficient and responsive dynamic way. The continuous WHCA* may enables functionalities like for example one or more of creating and deleting carriers in the WHCA* algorithm at any time, e.g., if on the real system a carrier is placed from, e.g., an analyzer onto the transport system and vice versa, changing final destinations of carriers at any time, for instance if an analyzer is not available anymore and a new one is assigned, considering stochastic variations in the movement times due to, e.g., friction effects of the carrier with the transport surface, considering that movements can fail due to, e.g., broken transport elements, considering that the execution of movements according to the planned times can fail due to, e.g., worn down transport elements or dirt, considering that positions can suddenly become untraversable, e.g., due to malfunctioning or purposely turning off. An executing unit may be configured for providing sudden impediments detected by a sensor to the routing system and the routing system can cancel the affected plans and re-plan them.

The distribution system may be configured for distributing a high number of carriers, such as over thousands of carriers. The density of the carriers can be very high, up to levels where many carriers are blocked by their neighbors such that they cannot make any movements until the traffic density is reduced. The continuous WHCA* may be designed for planning routes conflict free taking into account high density of carriers.

The intermediate destination is a logical position, which can be reached after the time T. The intermediate destination can also coincide with the final destination when the final destination is reachable within T.

When a carrier moves, it accelerates until it reaches a steady velocity after which it decelerates and stops at an intermediate or destination position. For very short moves, e.g., 1 logical position, there may only be acceleration directly followed by deceleration. In such cases a steady velocity will not be reached.

The term “infinite reservation time” may relate to an additional status of a logical position, used by the router to indicate that the position is not available for routing. Initially, all positions may be available. If the position is set to “reserved” for a finite duration, the position will be available again for a move once the temporary reservation is over. If the position is set to “infinite reservation time” from a certain time on the router will not consider the position anymore from said time on in his plans. However, up to said certain time the router will take said position into account, too.

Infinite reservations are entries in the reservation tables which begin and/or end at −infinity and +infinity respectively. This may be used by the router to indicate that the position is not available for routing. If the position is set to “reserved” for a finite duration, the position will be available again for a move once the temporary reservation is over. If the reservation starts and ends at infinity, the router will not consider the position anymore in its plans. If the reservation starts at a finite time and ends at infinity, the router will only be able to use this position in available time windows before the start of that infinite reservation.

A first aspect of the present disclosure concerns a distribution system comprising a transport plane for distributing objects. Carriers transport the objects on the transport plane. The carriers are moved by a drive system, on the transport plane. The system further comprises a control system configured to control the drive system so that the carriers move on planned routes from a start position to a final destination position on the transport plane. The control system comprises a routing system. The routing system is configured to calculate routes for all carriers on the transport plane by modelling the transport plane with a graph of nodes. To do so the routing system is configured to determine reserved and free time windows for each node. To calculate routes for the carriers the routing system uses a windowed hierarchical cooperative informed search algorithm with cooperative time window T. In particular the cooperative informed search algorithm is a Dijkstra-, Bellman-Ford- or more in particular an A*-algorithm. T is typically in the range of 1 to 300 secs in particular ca. 10 secs. The routing system is configured to assign an individual reservation length as a number of nodes for the next move on logical positions with free time windows for each carrier, so that the carriers start and stop individually. An infinite reservation time is assigned to a logical position on the transport plane. An infinite reservation time may be assigned to a logical position on the transport plane for as long as no movements are planned for the carrier on that position or if the position is marked as not available. The control system comprises at least one executing unit configured for executing the planned routes for transporting the carriers from their respective start position to their respective final position.

The calculating of the planned routes may comprise planning the routes. The control system may comprise the routing system for planning the routes of the carriers. The planning may comprise determining optimal routes for the carriers across the transport plane. The optimal route may be determined in terms of at least one optimization target such as one or more of time, resource consumption, cost, wear balancing, good overall transport performance. Since the routing is cooperative, the routing system may take care that all carriers find their way through in a net efficient way, if necessary, sacrificing the shortest times to the final destinations of individual carriers. The optimal route for a respective carrier may be a route selected from a plurality of possible routes which minimizes the optimization target, e.g., the time needed for reaching its final destination position. The planning may comprise considering not only one carrier on its way across the transport plane but considering the plurality of further carriers present and/or obstacles and/or failures of at least one physical entity and the like. The planning of the routes may comprise receiving status update information about the transport plane and/or the drive system. The status update information may be information about logical positions such as presence or absence of obstacles, carriers passing logical positions, carriers starting/finishing moves, failures of a physical entity corresponding to a logical position. Failure information may be sent separately to the control system, wherein the control system may inform the routing system to, e.g., take out certain positions for routing or reserve a position with infinite reservation time. The routing system may be configured for identifying jams or dead-locks by looking at the lack of moves for a certain duration. The routing system may be configured for calculating, in particular computing, a route for a carrier depending on the received status update information. The routing system may be designed as a computer or computer network for performing the planning of the routes.

The routing system may be configured for proposing routes for the carriers which are then executed by the executing unit. The control system may comprise the executing unit for executing the planned routes. The routing system and the executing unit may be deployed in the same computer or may be embodied as separate devices. The control system may comprise at least one transfer connection for transferring information about the planned routes from the routing system to the executing unit. For example, the transfer connection may be wire bound or wireless, e.g., designed as Internet connection, Bluetooth connection, NFC connection, inductive coupling or the like.

Specifically, the executing unit initiates the planned routes. The executing unit may be designed as a computer or computer network for running the executed processes, in particular for moving the carriers. The planned routes may be generated such that no collisions will happen. The distribution system may be configured for prohibiting collisions via good routing because of the following mechanism: the executing unit will send the information to the routing system about carrier that have arrived at certain points, e.g., crossing modules or areas, arrived at end-of-move. So the routing system will know that the reserved positions that were passed already are safe to be used for next carriers, without the risk of collisions. Optionally, also the executing unit may take care that no carriers will collide. The executing unit may be configured that in case the executing unit would receive an erroneous plan (hypothetically), where collision would happen, it will halt, doing nothing anymore. Thus, the executing unit may comprise an additional safety mechanism.

The executing unit may try to execute the planned routes as well as it can by moving the carriers. Transport methods, like where carriers are driven by a combination of electromagnetic forces and friction, show stochasticity in the velocity profile of the moving carriers. Friction forces between sliding surfaces in general can be a rather varying factor, for different carriers and over time. Additionally, surfaces of carriers and the transport sliding surface may not be uniform over the full surface. The roughness may vary over the transport surface, for instance due to differences in wear, material inhomogeneities, dirt or dust or moisture etc. Also some module surface plates may have been renewed more recently than others and therefore show a different friction level than older plates. The same will be the case for the contact surface of the carrier with the transport surface. As a consequence of these varying friction forces, the time a move takes may have an unpredictable, stochastic component as well. If the actual friction is higher than average, the carrier will accelerate slower and may not reach the average plateau speed. Also, it may cause the carrier to decelerate faster. The executing unit that controls the moves may try to regulate this, but still a variation in acceleration and speed profiles will be shown for the moves and carriers. Thus, due stochastic effects, exceptions and errors, not all planned routes may be executed exactly as proposed by the routing system.

The transport plane may comprise at least one sensor configured for detecting status information of the transport system. For instance, the status information may comprise one or more of the position of the carriers, unavailable or broken positions or nodes on the transport plane, or dirt on the transport plane. For example, the sensor may be or may be part of a camera system and appropriate image processing. Other position sensing systems such as Hall-Sensors, current sensors, conductive sensors, capacitive sensors, inductive sensors, or optical barriers are also possible. The sensor may be configured for providing the detected status information to the executing unit. The executing unit may be configured for updating the latest status information depending on the received detected status information thereby generating the status update information. The executing unit may be configured for providing the status update information about the transport plane, transport carriers and/or the drive system to the routing system.

The routing system is further configured to assign an infinite reservation time to a logical position on the transport plane. The routing will lose some cooperation but avoids the infinite computational loops which is a known drawback of informed search algorithms.

In a further embodiment of the distribution system the routing system is configured to assign an infinite reservation time to the logical position if one or more of the following is realized:—the logical position is the position of a carrier without a final destination,—the logical position is broken or blocked,—during the cooperative time window T no possibility is found to move the carrier on the logical position.

So either one of these situations are possible or two in combination or all three for different logical positions on the transport plane.

A reservation time assigned to a logical position may be or may correspond to the time duration a carrier is planned and/or expected to move over said logical position. The routing system may reserve in its plan one or multiple positions for as long as a carrier may need, in particular according to its model, to make a move over one or multiple positions. For example, all positions for a move may remain reserved as long as the complete move will take. For example, positions may be reserved for as long as the move will last in a certain logical area. For example, positions may also be reserved until that position is passed by the carrier. For example, positions may be released as soon as each logical position is passed. For example, positions may be released in case a border of a block of logical positions is passed. The routing system may be configured for assigning different types of reservation time to logical positions depending on temporary non-availability or permanent non-availability for route planning. The routing system may be configured for assigning a finite reservation time to logical positions expected to be temporarily occupied by a carrier. Thus, in case of a finite reservation time assigned to a logical position, said logical position may be available for route planning but temporary non-availability needs to be considered, e.g., by planning waiting time during the route. The routing system may be configured for assigning an infinite reservation time to logical positions expected to be not available for moving carriers, e.g., because the logical position is the position of a carrier without a final destination (e.g., carrier that is parked), the logical position is broken or blocked, or during the cooperative time window T no possibility is found to move the carrier on the logical position. The routing system may be configured for assigning an infinite reservation time to permanent non-available logical positions. In particular, the infinite reservation time may be assigned to logical positions non-available for planning the route. The routing system may be configured for assigning an infinite reservation time to said logical position such that the windowed hierarchical cooperative informed search algorithm can consider said logical positions as not usable or non-available. Specifically, the windowed hierarchical cooperative informed search algorithm can ignore the logical positions assigned with infinite reservation time for the search of a route. Otherwise, i.e., in all cases in which no finite or infinite reservation time is assigned to the logical position, the logical position is considered as free, in particular in the sense of available.

The status of a logical position may change during operation of the distribution system. For example, a status of a logical position considered as permanent non-available may change to “free” after maintenance. For example, a status of a logical position considered as free may change into permanent non-available in case of a broken physical entity of the transport plane and/or drive system

For example, the routing system may be configured for assigning an infinite reservation time to the logical position if the logical position is considered as broken or blocked. The logical position may be considered as broken in case the logical position cannot be used anymore such as due to failure of the drive system at this particular position of the transport plane and/or failure of the transport plane. The logical position may be considered as blocked in case the logical position can in principle be used, i.e., is the physical entity at this logical position is functioning properly, but the logical position is reserved by a carrier. The routing system may be configured for taking into account failures and/or changes and/or obstacles of the drive system and/or transport plane for planning a route. For example, presence of other carriers on the transport plane may have influences on the potential routes of the carriers. For example, the routing system may be configured for taking into account traffic, traffic jam, reserved logical positions, dirt and the like. For example, routing system may be configured for taking into account changes of the drive system and/or transport plane such as a failure of one of the electro-magnetic coils. In particular, the routing system may be configured for preventing moving the carriers to a logical position hindering further transport of the carrier. The routing system may be configured for taking into account failures and/or changes and/or obstacles by assigning infinite reservation time to said logical positions. The routing system may be configured for assigning an infinite reservation time to said logical position such that the windowed hierarchical cooperative informed search algorithm can consider said logical positions as not usable or not available. The routing system may be configured for assigning an infinite reservation time to logical positions occupied by carriers which have not been routed yet. For example, if the system is rebooted and thus all carriers have no plans and must be routed at the same time, then the routing system may assign infinite reservations to the positions of all carriers except the one which is to be routed first. For example, if a failure caused several carriers' plans to become void, the routing system may cancel those plans and similarly have to route several carriers without plans at the same time. Infinite reservations may be used in the routing system to enforce route plans in which the positions with infinite reservations are ignored, for creating routes, as long as the infinite reservation is activated, whether there is a physical reason for it or just a software-set reason.

A further aspect of the distribution system is that, multiple, e.g., n, moves, each with an own reservation length and duration t, are started within the cooperative time window T. The last of the planned n-moves start in the cooperative time window T but does not need to end during this cooperative time window. So it can be concluded that T≤Σᵢ₌₁ⁿ tᵢ. The lengths and durations tᵢ of moves depend mainly on the density of traffic. At high traffic density, more but shorter moves with shorter times tᵢ will be made as there will be a more intense interaction between the carriers (e.g., crossing the paths). The reservation length may be the number of nodes and/or logical positions reserved for a move. The term “move” may refer to the “action” and may not include the waiting time before the next move will take place.

The duration of a move may depend on the reservation length. A move is defined in this disclosure as one movement of a carrier in a straight line, starting from one logical position and stopping at a second, different logical position. A move can consist of a displacement of a carrier of 1 or multiple logical positions. Moving from a first final destination to a second final destination may be carried out in one or more moves with intermediate destinations. There can be a longer or shorter waiting time at each intermediate destination before the next move will start. A routing plan can comprise all moves or only the next few moves to carry out until a second final destination is reached. The moves can have different reservation lengths, not exceeding a maximum reservation length. A reservation length for each move may comprise the logical positions that shall be reserved to make the move. A maximum reservation length may be defined to avoid situations where too many logical positions are reserved at once, which would lead to blocking these positions for other carriers for a too long time. By having a model for estimating the times the moves will take for a given move length, a complete time plan can be made for reserving the logical positions. This time plan may comprise move times as well as waiting times until next moves can be made and infinite reservation times for positions that shall not be used or contain carriers without a plan for moving to a next destination.

For a diagnostics laboratory transport plane with a cooperative search window of ca. 10 sec n can be between 1 and 12, in particular between 3 and 8, more in particular 6.

In further embodiments the reservation lengths are defined for moves specifically, for instance carriers in certain areas can make longer moves than in other areas.

A further aspect of the distribution system is that the routing system is configured to use the most reservation length available in particular equal or below a determined maximum reservation length for the next move of the maximum n moves possible in the cooperative time window T. In particular the routing system is configured to use a maximum reservation length so that n>1. The maximum reservation length for a move is defined as a fix number. In other embodiments the maximum reservation length is adjustable in time, such that during situations with low traffic density longer moves can be made.

In further embodiments, the routing system is configured to limit the maximum reservation length for a move to avoid blocking fields unnecessarily for too long time. This set maximum reservation length is required in order not to block too many logical positions for other moving carriers.

In another embodiment not the complete route during this cooperative search window of time length T needs to be executed according to the calculated route. A carrier may arrive earlier at the intermediate destination position which is the last reserved logical position, such that a new route can or needs to be made earlier than after the time window T. Typically a new route is computed after a defined duration has elapsed, for instance 20% of the cooperative search window time T or directly after the transport system sends an update that triggers the need for calculating a new route, such as a failed route or failed move or reaching the final or intermediate destination. This allows improving throughput with much more up to date information of the situation on the transport plane for calculating the routes. So the routes are more efficient because the accumulated uncertainty is reduced.

Another aspect of another embodiment of the distribution system is that the routing system is configured to receive status information from the transport system. The received status information is stored in a storing device and compared with the latest status information stored in the routing system. When a change in status is detected by this comparison, a reservation map used by the routing system is updated and new, eventually changed, routes with new reservation lengths are calculated for the carriers. Status information can be, e.g., whether a carrier crossed a predefined border on the transport plane or when it left, passed or arrived at any or a pre-defined logical position or when errors have been detected by the transport system.

In further embodiments of the distribution system errors in the distribution system include, e.g., broken logical positions, which are out of order, broken or stuck carriers which cannot move anymore and their related logical positions, a blocked final destination position due to unavailability of the system corresponding to the final destination position.

In other embodiments of the distribution system the frequency of transport surface usage for each logical position can be a status information of the transport system.

In another embodiment the routing system is adapted to calculate the status information itself from the plans the routing system, also denoted as router herein, makes and its detected deviations.

A further aspect of the distribution system is that the routing system is configured to determine subsequent routes after the current route, assuming that each route will be successfully executed.

This allows for faster routing because when the moves are checked to be successful meaning that each carrier reached its planned intermediate or final destination according to the current route, the moves for the next route can be directly executed without losing time computing it first because the route is already available. This further allows for better CPU usage of the routing system with a continuous instead of peak computation load.

Another aspect of the distribution is that the routing system is configured to check whether all carriers arrive within the planned time windows and when carriers are detected which will not arrive within the planned time window the planned time window for these carriers which did not arrive to their stop or intermediate or final destination position will be stretched and affected plans are stretched respectively.

In a further embodiments affected plans, i.e., routes, are recomputed.

In a further embodiment, depending on the physical effects and control mechanism like friction and discontinuous driving forces, the acceleration, steady velocity and deceleration may not have constant values but may vary over time. The time duration for the move from the start to the stop may vary consequently. For defining realistic time windows for the moves and thus for reservations of the logical positions, acceleration, steady velocity and deceleration values are assumed. For instance, the slowest expected accelerations and decelerations and the lowest velocities are taken. Together with the number of logical positions to move, the time window for the move can be calculated. Eventually a slightly longer time, such as 5, 10, 20 or 30 percent, is taken to avoid creating too many failing plans.

In another embodiment the sensible length of the cooperative search window T depends on the level of uncertainty of planning into the future and the amount of computational time needed to compute a next set of moves. With strong stochastic move behavior, the certainty that a future move can be executed as planned is lower than with a strong deterministic move behavior. Hence, the time length of the cooperative search window T is chosen shorter for a strong stochastic movement behavior and is chosen longer when a strongly deterministic behavior dominates. Making plans with longer cooperative search windows T and thus more moves, costs more computation time per route. The aim is to plan with sufficiently large cooperative search window T and with high certainty that all of the contained moves in that time window can be executed. This would lead to less frequent re-planning and therefore a reduction of computation power.

In a further embodiment instead of using a formula to calculate the time window for reserving the positions, also a lookup table can be used with pre-calculated times to move 1, 2, 3 , . . . nmax positions, where nmax is the maximum reservation length. These times are based again on modelled or empirically determined velocities, accelerations and decelerations. The positions may not be equidistantly distributed. For instance, the distance between 2 logical positions at each side of the border of a transport tile may be larger than the distance between 2 logical positions inside a tile. Consequently, moving from 1 tile to the next may take additional time due to crossing the border. The model for calculating the time may take this additional time into account.

A further aspect of the distribution system is that the routing system is configured to allow at least one of the logical positions to be only addressed as final destination position by the carriers and forbidden to be used as intermediate destination position to transport carriers towards their final destination position.

This allows for smooth handover of objects transported by the distribution system to, e.g., separately managed transport areas or systems such as analyzers in a diagnostic lab.

Another aspect of the distribution system is that the transport plane is divided into logical subareas.

This allows for organizing the subareas without a need to organize the whole system. Subareas can be defined by hardware modules, e.g., the transport system is built from individual modules. Also the subareas can be defined by logical areas, e.g., handover areas for the objects, fast transport areas, sorting areas, buffer areas to have some kind of intermediate storing of objects, areas for empty carriers, or modules powered by one power unit.

Different behaviors of the carriers can be allocated to the sub-areas such as different driving speed, acceleration or deceleration behavior of the carriers, special rules for moving carriers, e.g., first in first out in a queue, etc.

An additional aspect of the distribution system is that the routing system is configured to allow only a limited number of simultaneous moves of carriers within defined subareas of the transport plane.

Furthermore, it is advantageous for passive carriers to design the power-supply for the drive system with a defined maximum threshold for power consumption by limiting the maximum possible power draw for the logical area.

Another aspect of the distribution system is that the routing system is configured to release each node reserved by the current move on a subarea after the carrier passed a predefined logical position on the transport plane. Releasing a node means here that in the node information the respective time window of the respective logical position is set from reserved to free. As a first example, every node is directly released for further planning after the carrier has passed the respective logical position and reached the next logical position on his planned move. Another possibility is to release all nodes in a subarea after the carrier has passed the border of the respective subarea.

These borders can coincide with logical entities of the transport system, e.g., a border of a transport surface module with the next modules if the transport plane is build out of transport modules like tiles. Other borders could be defined artificially by defining logical positions that form the defined border, or by a sensing system that detects if a carrier has passed, entered or left a pre-defined position, such as by an optical gate or camera system, inductive, capacitive, conductive or radiofrequency sensors.

A further aspect of the distribution system is that the routing system is configured to check the success or failure of the planned move and wherein either the parameter of the planning model is adapted of the complete transport area with same values or for each subarea with different values, depending on the number of failed plans in the related area. As outlined above, due to stochastic effects, exceptions and errors, not all routes planned by the routing system may be executed as proposed by the routing system. As long as an execution time for executing the planned route is within a planned time range, the planned route can be executed. The routing system may be configured for monitoring execution time and planned time range for checking the success or failure of the planned move. For example, the routing system may be configured for counting a number of moves that exceeded the planned time range. The routing system may be configured for determining a move, in particular an individual move, as “success” in case the execution time for executing the move is within the planned time range at least within tolerances. However, in case the execution time for executing a move of the planned route exceeds the planned time range, this may potentially violate other moves and result in failed plans. For example, if moves in a certain area fail to execute their plans frequently, this may be an indicator that the model is too optimistic for this area. For example, if it is detected that a carrier fails executing its individual moves frequently, wherever the carrier is located on the surface, the system can identify that the carrier does not move anymore according to the model for a “healthy” carrier. The reason could be, for instance, a worn-down sliding surface of the carrier or dirt on the carrier's sliding surface. Based on this information the control system may either take out the carrier or adjust the planning model for the carrier and eventually register the poor condition of the carrier, such that it can be renewed or cleaned by the next system service. The routing system may be configured for determining a move as “failure” in case the execution time for executing the move exceeds the planned time range. The routing system may be configured for determining a “failure” in case a number of moves that exceeded the planned time range exceeds a predefined threshold. For example, a threshold may be used for the maximum allowed number of failures per time or area or carrier. In case of determining a failure, the routing system may be configured for either adapting the parameter of the planning model of the complete transport area with same values or for each subarea with different values, depending on the number of failed plans in the related area. For example, the routing system may be configured for adapting parameters that define the reservation length in the planning model.

The system conditions can influence the possibilities of the carriers to move. So the parameters of the planning model can be adapted to reflect the real possibilities of the carriers in the routing system. The planning model codifies the movement possibilities of the carriers, which means as parameters the acceleration/deceleration and the maximum speed achievable or determined.

In another embodiment of the distribution system the routing system is configured to measure the deviation between the modelled and the real move times and adjust the parameters of the planning model respectively.

An additional aspect of the distribution system is that the routing system is configured to adapt the maximum reservation length depending on the deviation of the planned reservation length with the maximum reservation length. The routing system may be configured for performing at least one self-learning algorithm for optimizing the maximum reservation length in terms of successful routes. Specifically, the routing system may be configured for comparing the planned reservation length with the maximum number of logical positions which can be reserved for a move. The planned reservation length may be the reservation length the routing system considers as optimal in terms of a successful route for the planning of the route of carriers. The planned reservation length may be the individual reservation length assigned to a move. The maximum reservation length may be a boundary condition of the planning model defining an upper limit of possible reservation lengths. The routing system may be configured for adapting the maximum number of logical positions which can be reserved for a move depending on a deviation of the planned reservation length with the maximum number of positions which can be reserved for a move.

Adapting means here that the maximum reservation length used for the routing plans is made longer if the majority or 80% or 90% or 100% of the planned routes of the carriers using a moving length equal to the maximum reservation length. This speeds up the system or at least areas with low traffic intensity or high level of parallel moves.

A further aspect of the distribution system is that the routing system is configured to count the number of failed plans for each carrier and/or subareas of the transport plane, and if the number of failed plans exceeds a predefined number or the frequency of failing exceeds a predefined number, either the carrier is marked as “maintenance needed” in the control system for each carrier or the nodes in the subarea are marked as “maintenance needed” or not used anymore for further routing in the routing system or the use is minimized, only if necessary to avoid transport problems. The routing system may be configured for determining how often logical positions have been involved in plans that failed and/or what actions the routing system will trigger in case a threshold number is exceeded such as one or more of excluding the logical positions from routing, notify need for maintenance, and the like. The distribution system, such as the control system, may comprise at least one user interface configured for displaying at least one information, e.g., that maintenance is needed, in case the number of failed plans for each carrier and/or subareas of the transport plane exceeds a predefined number or the frequency of failing exceeds a predefined number. The user interface may be configured for interacting with its environment, such as for the purpose of unidirectionally or bidirectionally exchanging information, such as for exchange of one or more of data or commands. For example, the user interface may be configured to share information with a user and to receive information by the user. The user interface may be a feature to interact visually with a user, such as a display, or a feature to interact acoustically with the user. The user interface, as an example, may comprise one or more of: a graphical user interface; a data interface, such as a wireless and/or a wire-bound data interface.

The marking can be done in a log file or a registry file stored in a storing device of the routing system, in memory or in a database. This allows to regularly check for carriers with problems to sort them out or send them by respective routing/destinations to a maintenance or exchange area for carriers on the transport plane. Furthermore, it is possible to identify areas on the transport plane on which carriers do not move appropriately anymore. So these area can be avoided or less used for routing or also checked for maintenance, dirt or for active transport planes checked for problems with the driving means and take necessary measures to solve the respective problem by, e.g., cleaning the transport plane or exchanging the transport surface or module.

In a further embodiment of the distribution system areas and carriers can also be visually marked, for instance by changing the color of LEDs built in the surface or carriers, or be indicated on a screen of the control computer or mobile client devices.

Another aspect of the distribution system is that the routing system is configured to allocate a used-cost to a node depending on how often a carrier moved over, started or stopped on this node and minimize the used-cost for each planned move.

This will provide for an equally distributed use of the transport plane. Acceleration on start positions/nodes and deceleration on end positions/nodes loads the transport plane more so the number of acceleration and deceleration can be included in a cost function to balance it over the nodes as well. By this, the life-time of the system and reliability can be increased and maintenance can be reduced.

A further aspect of the distribution system is that the routing system is configured to check whether carriers are blocking each other such that for k>1 carriers there is no possibility within infinite time to make their moves. This situation is indicated as “dead-lock”.

A further aspect of the distribution system is that a dead-lock situation is also identified by the routing system if no move is found for the next tₒᵤₜ seconds, with tₒᵤₜ being configurable, e.g., in the range in the range of 2 sec to 60 sec or 2, 5, or 10 sec.

Another aspect of the distribution system is that the routing system is configured to check whether a dead-lock situation has occurred. The routing system may be configured, in case a dead-lock situation is detected, for ignoring for all involved carriers the metric for the final destination such that all involved carriers will make one or more moves chosen from possible moves ignoring the metric for the final destination. In particular, the moves may be chosen randomly. This may allow creating space that leads to resolving the dead-lock situation. In particular, all carriers on the transport plane or a defined area of the transport plane make one or more moves chosen from possible moves ignoring the metric for the final destination. In the case a dead-lock situation is detected, for all carriers in a neighborhood of an origin of the dead-lock situation, the next n-moves may be chosen from possible moves ignoring the metric to the final destination, in particular are chosen randomly. The dead-lock may be initiated by a few carriers and may involve other carriers as well.

Ignoring the metric to the final destination let the carrier move in all directions, i.e., also backwards, or orthogonal to the direction of the final destination.

Some or all of the involved carriers in a dead-lock make possible moves, different from a move that would fulfill their objective of reaching the final destination position within the shortest time or distance. Randomly can be realized with a random number generator normalized to all possible moves for each carrier. Such moves can be made with random direction and move length. So for n-moves the carriers behave like Brownian motion.

In an alternative embodiment the move direction and length could be chosen with determined values, for instance, to make moves that create a free passage in a chosen direction or pattern of free positions between carriers involved in the dead-lock situation. After these moves the regular routing process is applied again to the carriers, including the carriers previously involved in the dead-lock.

In another embodiment for the routing system a status of the carriers is either “moving over the reserved logical positions” of the planned move or “waiting at a logical position”. If no move can be calculated for a carrier it will wait until a move becomes possible. If, during the cooperative time window T no possibility is found to move a carrier, the node at which it has to wait is assigned with an infinite reservation time. During a subsequent planning a possibility to move the carrier may be found after which its node will be assigned with a limited time reservation. Also nodes at which carriers reside without destination, e.g., carriers waiting to be used, or nodes that need to be blocked for a duration, longer than the cooperative time window T, will receive an infinite reservation time. This method avoids the cooperative A* cycling problem resulting in infinite cycles. Additionally the method can be used to prevent the nodes from being used, for instance when servicing parts of the transport system.

A further aspect of the disclosure is a method for a distribution system to move carriers on a transport plane. The distribution system comprises a transport plane and carriers to transport objects and a drive system to move the carriers on the transport plane. A control system of the distribution system controls the move of the carriers on planned routes from a start position to a final destination position on the transport plane. A routing system of the distribution system models the transport plane with a graph of nodes. The nodes are logical positions on the transport plane at which the carriers can start and stop, i.e., start positions or final or intermediate destination positions possible for the carriers. The routing system determines free and reserved time windows for at least a part of the logical positions. The routing system calculates routes for at least two carriers on the transport plane using a windowed hierarchical cooperative search algorithm with cooperative time window T. The routing system assigns an individual reservation length to each of the carriers for the next move within the cooperative time window T. The routing system assigns an infinite reservation time to at least one or more logical positions.

In particular infinite means here at least for the time window T.

In a further embodiment of the method the routing system is configured to assign an infinite reservation time to the logical position if one or more of the following is realized:—the logical position is the position of a carrier without a final destination,
the logical position is broken or blocked,—during the cooperative time window T no possibility is found to move the carrier from the logical position.

Infinite means here that the logical position is reserved until the condition which leads to the infinite reservation is resolved, e.g., a new final destination is assigned to the carrier, the logical position is repaired or unblocked or a new possibility to move is found.

The routing system may be further configured for assigning an infinite reservation time to the logical position if the logical position is the position of a carrier whose route has not been planned yet and/or if the logical position is the position of a carrier whose route was/had to be cancelled.

A heuristic is used to ensure that the carrier heads to its final destination position, tables of pre-computed or measured travel times from each logical position to each other logical position or from each logical position to the relevant final destination position are stored within the routing system or control system. To pre-compute these travel times it is assumed that the carrier can move with a predefined velocity, acceleration and deceleration without being hindered by any other carriers to its final destination position. The predefined velocity, acceleration and deceleration can be based on a measured velocity of a real carrier or an arbitrary velocity such as 1 m/sec.

In another embodiment of the method the distance of the logical positions to the final destination positions can be used for such a look up table to guide the carriers towards their final destinations position.

The heuristic ensures that the routing system can choose as next nodes not only these nodes where the logical position has a free time window but also these nodes and hence logical position which decrease the travel time or the distance to the final destination.

A further aspect of the method is that the routing system uses the most available reservation length for each straight move of a carrier with available free time windows on its route, smaller or equal to the predetermined maximum reservation length.

This allows for fast and reliable routing of carriers of a distribution system. So while cooperatively searching for free time windows of logical positions for the carriers on their routes to their destinations the search is stopped for the individual carrier if no logical position with a necessary free time window is available for the next move. Theoretically, this could be its final destination. Each carrier can have a different individual reservation lengths planned for the next move.

Another aspect of the method is that the routing system receives status information of the transport system, stores this status information on a memory device of the routing system and compares the status information with the previously stored status information. When the routing system detects a change in status of the transport system by this comparison the routing system calculates new routes for the carriers for the next moves with new reservation lengths considering the most recently known status of the transport system. In addition, if a new destination is assigned to a carrier, new routes are calculated.

The communicated status information can be that carriers have passed some software defined or hardware borders on the transport plane, i.e., moved from one specific area of the transport plane to another, reached their final destinations, or information that some areas of the transport plane are blocked or out of order or some carriers are out of order etc.

In a further aspect of the method the routing system determines subsequent routes after the current move assuming that each move of the carriers will succeed.

This allows for faster or even continuous execution of the moves directly after the specific carrier reached the final or intermediate destination of the last planned move and a more efficient use of the computer resource capacity.

A further aspect of the method is that the routing system checks whether all carriers arrive within the planned time window and when carriers are detected which will not arrive within the planned time window the next planned reservation length will be stretched and affected plans of other carriers are recomputed. In particular, the routing system may be configured for prolonging the next planned reservation length. The distribution system may be a self-learning system. The routing system may be configured for adapting the planned reservation length automatically, in particular without any manual interaction. The routing system may be configured for automatically optimizing the planning of the routes. The optimizing may comprise optimizing parameters of the model in terms of successful routes.

A further aspect of the method is that the routing system allows at least one of the reserved nodes to be only addressed as final destination by the carriers and forbids the node to be used as intermediate point to transport carriers towards their final destination.

This allows reserving specific points/nodes on the transport plane for specific tasks, which are less occupied to perform their specific task. For instance, a hand over position to handle the objects from or onto a carrier can be such a special node on the transport plane. Another example can be a read out position where some kind of information of the object carried needs to be read or a handling position where some kind of operation is performed on or with the object.

Another aspect of the method is that the routing system allows only a limited number of simultaneously moves of carriers within a defined subarea of the transport plane.

For transport systems with a drive system in the transport plane this also avoids drawing too much energy in a specific area or enables using less or smaller power supplies.

A further aspect of the method is that the routing system releases each node reserved by the current move on a subarea after the carrier passed specified nodes on the transport plane.

These specified nodes can be just the last n^{th} nodes the carrier passed wherein n can be an integer between 1 and 20 or 1 and 10 or 1 and 5, or nodes at a border of the subareas of the transport plane wherein the nodes of the passed subarea are released at once.

Another aspect of the method is that the routing system is configured to check the success/failure of the planned moves, in particular for a defined area on the transport plane and/or for a carrier, wherein the routing system adapts the parameters of the planning model either for the complete transport plane or for a subarea with different values or for a carrier with individual values or for a carrier in a specific subarea, depending on the number of failed plans for that carrier or in the related area.

This allows to react on different properties of the transport plane a subarea on the transport plane or a carrier to make the routing system more efficient and reliable and also allows for faster routing.

A further aspect of the method is that the routing system adapts the parameters of the planning model depending on the deviations of the planned times for moves versus the current real move times for the carriers.

For instance, if the carrier reaches its destinations in time the carriers move velocity in the planning model can be increased, respectively the move times can be reduced. On the other hand, if the carrier does not reach its destination in the planned time the maximum speed can be decreased, respectively the move times are increased in the planning model.

In another embodiment of the method or distribution system depending on whether only the short moves fail, the acceleration/deceleration values are changed and the velocity values are kept the same. If only plans for longer moves fail, the velocity value is adjusted only.

This allows for more efficient or reliable routing.

Another aspect of the method is that the routing system counts the number of failed moves for each carrier and/or subarea of the transport plane, and if the number of failed moves exceeds a predefined number, or the frequency of failed moves exceeds a predefined number, either the carrier is marked as maintenance needed or the transport plane or the subarea of the transport plane is marked as maintenance needed or as not to used or to be less used for routing in the future.

In a further embodiment of the method, the control system specifies the carrier with maintenance needed and makes them to be routed to a specific maintenance area on the transport plane. Maintenance can then be performed, e.g., the carrier can be exchanged for new carriers, parts of the carriers can be exchanged for new parts, an energy storing device such as a battery can be charged or replaced or parts of the carriers can be cleaned or treated with maintenance substances/fluids.

For the transport plane maybe cleaning or a new surface, a new actuator or a new actuation electronics is needed or some obstacles need to be removed etc.

A further aspect of the routing is that the routing system allocates a used cost to a node depending on how often a carrier moved over, started or stopped on the said node and minimize the used-cost for each planned move.

Search algorithms use cost functions to determine the best found route. This cost function could depend on the real distance to the final destination or intermediate destination or, e.g., the Manhattan distance is used. Additional costs can be added to be optimized on this cost function to find a “best” route. So the best route does not need to be the shortest route in the sense of geometrical distance. Furthermore, other aspects can be considered in the cost function for instance, a route over areas on the transport plane which have been less used than others get lower costs or a route frequently used areas gets higher cost or routes with longer moves gets lower cost or routes with a typical distance to other carriers gets lower cost, routes with less changes of direction gets lower costs, routes over positions were less carriers started and stopped get less costs, etc.

In a further embodiment a further cost function can be realized as the cost of the consuming resources which can be calculated as the sum of all reservation lengths of all the planned moves and the waiting times of the carriers. Such a cost favors among other things, waiting a bit more rather than using a lot of resources to do zig zagging movements in order to arrive slightly faster.

A further aspect of the method is that the routing system use an A* algorithm for the informed search algorithm. This allows for a reliable and fast routing of the carriers.

However, other embodiments are feasible which relate to a combination of features disclosed herewith.

In the above all features of the system can be used in the method and all method steps can be performed by the respective system or part of the system which is adopted to do so.

The wording “embodiment” and “aspect” are used as synonyms.

Summarizing and without excluding further possible embodiments, the following embodiments may be envisaged:

Embodiment 1. A distribution system comprising

a transport plane comprising logical positions for distributing objects,

carriers for transporting the objects,

a drive system to move the carriers on the transport plane between the logical positions,

a control system configured to control the carriers to move on a planned route from a start position to a final destination position on the transport plane,

wherein the control system comprises a routing system configured to calculate the planned route for at least two carriers on the transport plane by modeling the transport plane with graphs of nodes and using a windowed hierarchical cooperative informed search algorithm within cooperative time window T,

wherein the routing system is configured to determine reserved and free time windows for each logical position

characterized in that the routing system is configured to assign an individual reservation length to each carrier for the next move on logical positions with free time windows,

wherein an infinite reservation time is assigned to a logical position on the transport plane.

Embodiment 2. A distribution system according to the previous embodiment, wherein the routing system is configured to assign an infinite reservation time to the logical position if one or more of the following is realized:

the logical position is the position of a carrier without a final destination,

the logical position is the position of a carrier for which a plan has not yet been made,

the logical position is the position of a carrier whose plan was or had to be cancelled,

the logical position is broken or blocked,

during the cooperative time window T no possibility is found to move the carrier from the logical position.

Embodiment 3. A distribution system according to the previous embodiments, wherein the routing system is configured to use the most reservation length available for a straight move, in particular below a determined maximum reservation length.

Embodiment 4. A distribution system according to the previous embodiments, wherein the routing system is configured to receive status information of the transport system and in particular compare the status information with the latest status information stored in the routing system and more in particular when a change in status is detected by this comparison new planned routes with new reservation lengths are calculated for the next moves.

Embodiment 5. A distribution system according to one of the previous embodiments, wherein the routing system is configured to determine subsequent planned routes after the current move assuming that each move will succeed.

Embodiment 6. A distribution system according to one of the previous embodiments, wherein the routing system is configured to check whether all carriers arrive within the planned reservation length and when carriers are detected which will not arrive within the planned reservation length the next planned reservation length will be stretched and affected plans of other carriers are recomputed.

Embodiment 7. A distribution system according to one of the previous embodiments, wherein the routing system is configured to allow at least one of the logical positions to be only addressed as final destination by the carriers and forbidden to be used as intermediate destination position to transport carriers towards their final destination position.

Embodiment 8. A distribution system according to one of the previous embodiments, wherein the transport plane is divided into logical subareas.

Embodiment 9. A distribution system according to the previous embodiment, wherein the routing system is configured to allow only a limited number of simultaneous moves of carriers within logical subareas of the transport plane.

Embodiment 10. A distribution system according to one of the two previous embodiments, wherein the routing system is configured to release each logical position reserved by the current move after the carrier passed a predefined logical position on the transport plane.

Embodiment 11. A distribution system according to the three previous embodiments, wherein the routing system is configured to check the success/failure of the planned move and wherein depending on the number of failed plans the parameters of the planning model are adapted either for the complete transport plane with same values or for the logical subareas with different values or for a carrier in particular on a specific subarea with individual parameters.

Embodiment 12. A distribution system according to the previous embodiments, wherein the routing system is configured to adapt the maximum reservation length depending on the deviation of the planned reservation length with maximum reservation length.

Embodiment 13. A distribution system according to the previous embodiments, wherein the routing system is configured to count the number of failed plans for each carrier and/or subareas of the transport plane and if the number of failed plans exceeds a predefined number or the frequency of failing exceeds a predefined number either the carrier is marked as maintenance needed or the transport plane or the subarea is marked as maintenance needed and/or avoided or used less for further routing.

Embodiment 14. A distribution system according to the previous embodiments, wherein the routing system is configured to allocate a used-cost to a logical position depending on how often a carrier moved over, started or stopped on this logical position and minimize the used-cost for each planned move.

Embodiment 15. A distribution system according to the previous embodiments, wherein the routing system is configured to check whether a dead-lock occurred and in the case a dead-lock is detected for all carriers in the neighborhood of the dead-lock the next n-moves are chosen from possible moves ignoring the metric to the final destination, in particular are chosen randomly.

Further optional features and embodiments of the disclosure will be disclosed in more detail in the subsequent description of typical embodiments, typically in conjunction with the dependent claims. Therein, the respective optional features may be realized in an isolated fashion as well as in any arbitrary feasible combination, as the skilled person will realize. The scope of the disclosure is not restricted by the typical embodiments. The embodiments are schematically depicted in the Figures. Therein, identical reference numbers in these Figures refer to identical or functionally comparable elements.

In order that the embodiments of the present disclosure may be more readily understood, reference is made to the following examples, which are intended to illustrate the disclosure, but not limit the scope thereof.

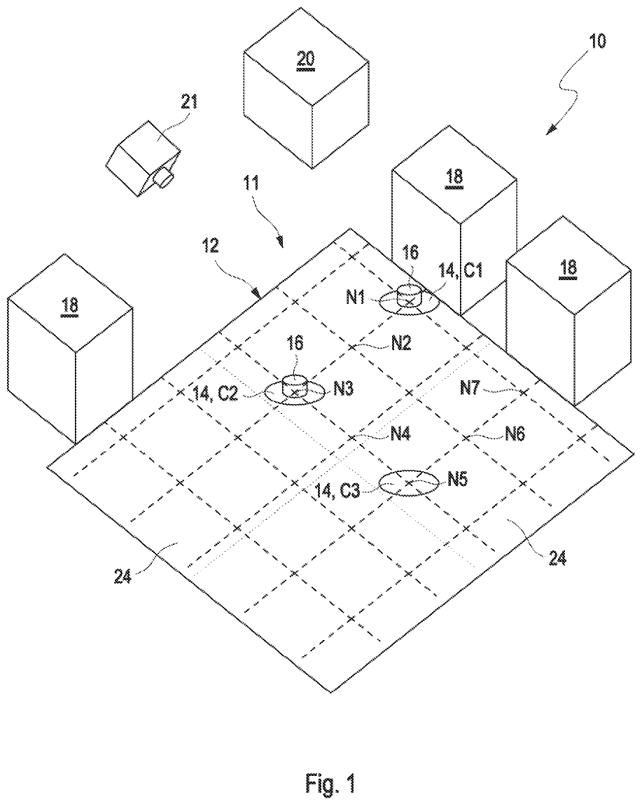

FIG. 1 shows a perspective schematic of a distribution system 10, e.g., a transport system of a diagnostics laboratory to get test results in particular for patients. The distribution system 10 is required to transport objects 16 in carriers 14 between stations 18 of the distribution system 10.

The distribution system comprises a transport system 11 with a transport plane 12 and carriers 14 also indicated as C1, C2, and C3. Each carrier 14 C1 and C2 carry an object 16 and carrier 14 C3 is empty. On the transport plane 12 carriers 14 are moved or move themselves. To move the carriers 14, the transport system 11 comprises a drive system. A drive system can be realized by electro-magnetic coils underneath the transport plane and permanent magnets in the carriers 14. Magnetic fields generated by the coils can then push and/or pull the permanent magnet in the carrier 14 and hence the carriers 14 over the transport plane 12. To localize the carriers 14 on the transport surface 12 sensors such as optical, magnetic, capacitive or inductive sensors can be embedded in the transport surface 12. Other option can be a camera system 21 with an image analyzing software to localize the carriers 14.

Other drive systems in other embodiments are also possible such as self-driving carriers 14 with sensors, motor and energy storage such as batteries in particular rechargeable batteries. So these self-driving carriers 14 can also drive autonomously over the transport plane 12. In this case the control device can also be part of the carriers or distributed over the carriers. 14.

The objects 16 can be handed over to the stations 18. The carriers 14 may wait for the objects 16 at the hand over position or drive away and the objects 16 are placed in another carrier 14 if needed after processing at the respective station.

In a further embodiment, the transport plane 12 can also be used inside the stations 18 to transport the carriers directly inside the stations 18.

For instance in a diagnostics laboratory, the distribution system 10 is used to transport, e.g., tubes with biological sample fluids and/or consumables or other species like tissue, reagents, waste or disposables between the stations 18. The stations 18 can be modules of the diagnostic laboratory, for instance an aliquot generating station, a centrifuge or an analyzing module performing one single analysis or whole analyzers, pre- or post-analytical stations, pipetting systems, incubators, mixers, or detection units. In other embodiments the distribution system 10 can be a warehouse distribution system to distribute goods as objects 16 between stations 18 such as shelves and packing stations, or a manufacturing site where objects 16 are blanks or semi-finished products which need to be transported between working stations, e.g., at a machinery workshop.

To control the moves of the carriers 14 a control system 20 is part of the distribution system. The control system 20 can, e.g., control the drive system, for instance the currents of the coils and/or collect position information of the carriers 14.

As shown in FIG. 7 the distribution system comprises a routing system 50, which can be part of the control system 20 or at least be connected to the control system 20 for information exchange. The routing system 50 comprises a computing device and a memory device to calculate a planned route for at least one or more carriers 14 on the transport plane 12 from a start position to a final or intermediate destination position. To do so the routing system 50 models the transport plane with graphs of nodes. The final routes or moves are sent to the control system 20 which sends the appropriate information to the drive system to move the carriers 14 on the transport plane 12 on the determined route.

The dashed lines shown in FIG. 1 represent the graphs or possible routes between their intersections, which define logical positions, e.g., N1 to N7. Not all logical positions are given a number in FIG. 1. In this example the graphs form a rectangular mesh. Also other models are possible with curved routes for example. For some drive systems the logical positions are given by technically possible start-stop positions on the transport plane 12. This is the case, e.g., for the drive system with coils under the transport plane 12. For self-driving carriers on the other hand purely software defined logical positions are possible, because the carriers can start and stop everywhere on the transport plane 12. At least the logical positions need a distance on the transport plane 12, so that two carriers 14 can be placed next to each other.

The routing system 50 determines reserved and free time windows for each logical position and uses windowed hierarchical cooperative informed search algorithm such as WHCA* to calculate a lowest cost route for at least two carriers 14 on the transport plane 12 from a start position towards a final destination position. This allows for cooperative routing within a cooperative time window by not losing the direction to the final destination. Usually several intermediate destination positions are necessary before the final destination position is reached. This depends on the dimensions of the transport system 12. A final destination position can be a handover position to a station 18 or a manipulating position at a station 18.

For example, in the case of a diagnostic laboratory, objects 16 such as tubes with biological fluids are placed into carriers 14 at one final destination positions from a pre-analytical system. Further final destination positions can be at station 18 such as an analyzer where either the tube is gripped and placed in the analyzer or a part of the fluid can be pipetted at the final destination position. These kind of final destination positions are also called hand-over positions because the object is handed over form the carrier 14 to a station 18 or vice versa.

For stations 18 with equal or similar transport systems in the station 18 itself the final destination position can be a logical position on the transport plane 12 where the carrier 14 can move into the station. In a further embodiment, the final destination position can be inside a station 18, e.g., a pipetting position in a diagnostic laboratory or a welding position in a manufacturing side.

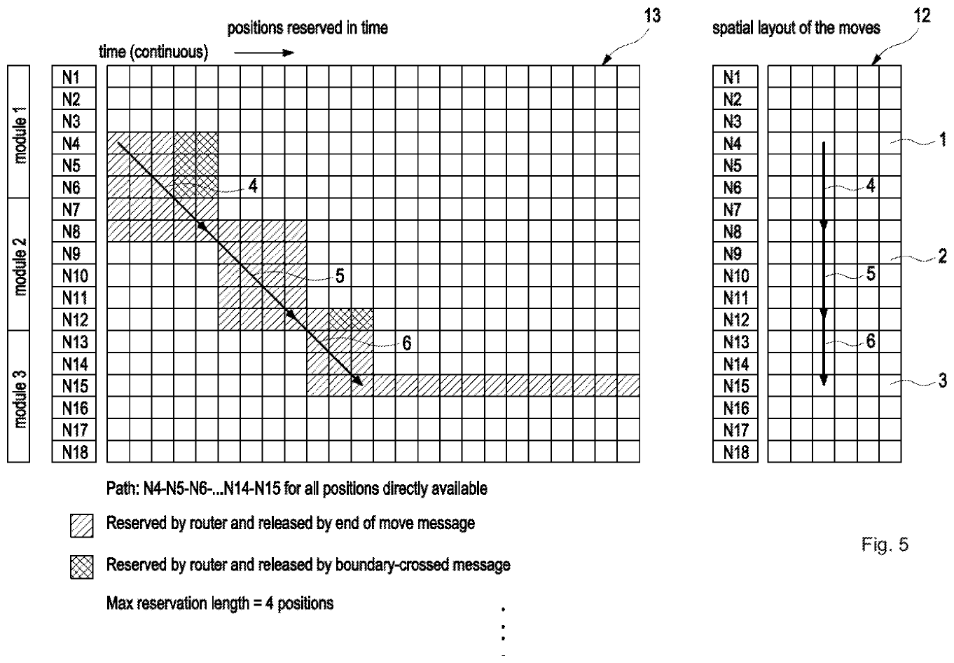

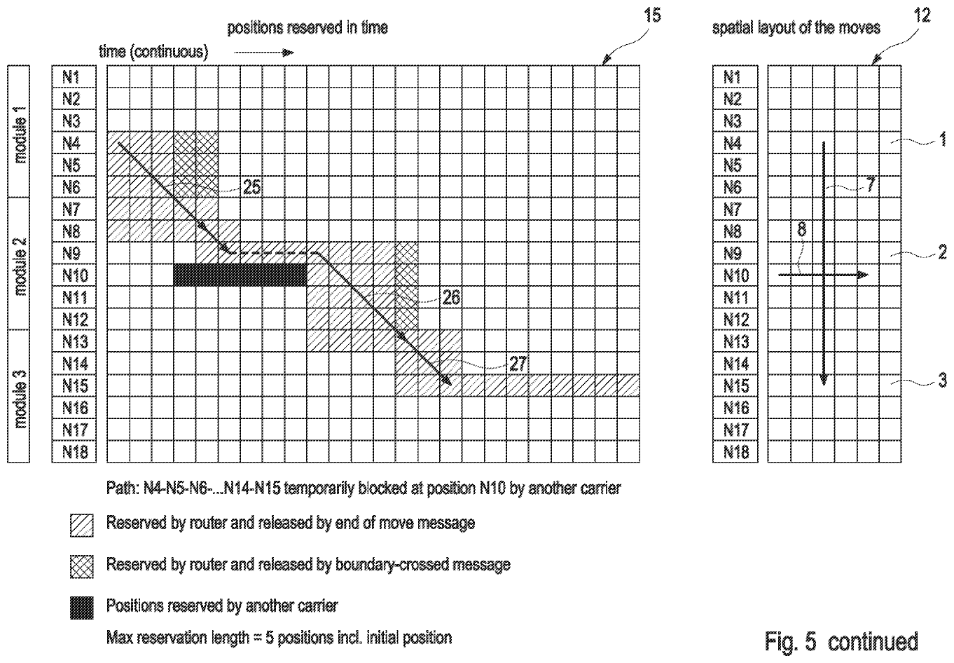

FIG. 5 shows the reservation tables 13, 15 and the route of two possible straight line moves of a carrier 14 on a further transport surface 12 along further logical positions N1 to N15 over three distinct modules 1, 2, 3. At the right hand side the logical positions N1 to N15 are shown on the transport surface 12 and the three moves 4, 5, 6 of the carrier 14. The left hand figures in FIG. 5 show the reservations in time for the situation when border-crossing release is implemented to release reserved logical positions earlier than at the end of each move 4, 5, 6.

The first move 4 on the first route in the upper figures of FIG. 5 of the carrier is from logical position N4 to logical position N8 using a set maximum reservation length of a move of four logical positions. As shown in the first reservation table 13, all logical positions N4 to N8 of this move are reserved for the required time of this first move 4, while moving from N6 to N7 the border between module 1 and module 2 is crossed and the reservations for the logical positions N4 to N6 are released before the end of the first move 4 at logical position N8. The logical positions that are released earlier, after the carrier has crossed a border of a module, e.g., from module 1 to module 2, are indicated by cross-hatching in the first reservation table 13.

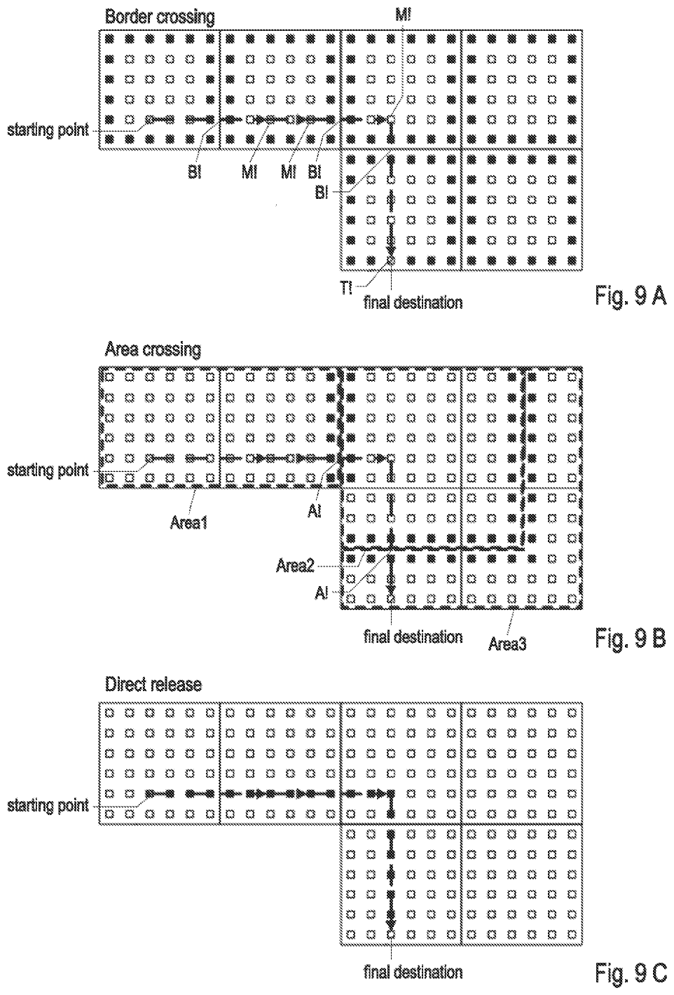

Further embodiments of how to release reserved fields are explained below with reference to FIGS. 9A, 9B, 9C.

As shown in the embodiment of FIG. 5 upper figures, after reaching the logical position N8, the logical position N8 remains reserved for the second move 5 with maximum reservation length of 4 logical positions ending at the logical position N12. Since no border of modules is crossed during this second move 5, no logical positions are earlier released. As can be seen in the first reservation table 13, the reserved positions are released upon end-of this second move 5, despite of the destination.

The last move for this route to its intermediate final position N15 needs only a length of 3 logical positions, which is below the set maximum reservation length for this embodiment. While passing the border between the module 2 and the module 3 the reservations for this move for the logical position N12 are released when the carrier reaches the module 3 at the logical position N13.

After the carrier has arrived at its destination point N15, again all reserved positions are released, except the destination position N15. This destination position keeps being reserved, theoretically an infinite reservation length, until a next move is carried out as shown by the long hashed line of N15.

In a further embodiment the reservation can be removed also when the carrier 14 is taken from the transport surface 12 (not shown).

It has to be emphasized that the squares in the reservation table along the time axis do not mean, that the time is discretized in this steps. For simplicity reasons the time is shown as discrete steps, whereas the presented method uses continuous time scales. The time is also not shown in scale. For instance, the last move with 3 logical positions will take more time than only ¾^{th} of the time the move along 4 logical positions will take because the acceleration and deceleration part in time is relatively higher than for a move along 4 logical positions.

In the upper figures of FIG. 5 the carrier does not meet any crossing traffic, such that max reservation lengths are used for the first 2 moves.

In the lower figures of FIG. 5 an example of a second route 7 is provided with a maximum reservation length of 5 logical positions from logical position N4 to logical position N15 as a straight line. Another route 8 of another carrier is crossing the route at logical position N10. For the calculation of the moves of the second route 7 this crossing is marked by the dark reservations on the logical positions of N10 in the lower reservation table 15. The first move 25 of the second route 7 starts at logical position N4 and stops at logical position N9. By passing from logical position N6 to logical position N7, the border between module 1 and module 3 is crossed and the reservations for logical positions N4 to N6 are released to be used for further moves. The second move 26 of the route 7 starts at logical position N8. Since the logical position N10 is already reserved for the another carrier, making move 8, the carrier can only reserve until logical position N9, where it has to wait until position N10 has become available again. After N10 is available again the second move, 26, is planned again for the maximum reservation length of 5 logical positions up to the logical position N13. Since the border between module 2 and module 3 is crossed between logical position N12 and N13, the reservations for the logical positions N9 to N12 are released when the carrier arrives at logical position N13. The third move 27 of the second route 7 starts at logical position N13 and stops at the logical position N15, which is the intermediate or final destination of the carrier for the second route 7.

Also here in the second reservation table 15 the time is shown by time blocks, which is only used to simplify the view. The algorithm however uses a continuous time scale.

In a further embodiment the routing system 50 adapts the maximum reservation length which can be assigned to a planned move depending on the density of traffic in the managed subarea of the transport plane. For instance, if more than 30% of the nodes in a subarea of the transport plane are occupied by carriers the max reservation length is set to 3 logical positions and if less than 30% of the logical positions in the subarea are occupied by carriers the maximum reservation length is set to 6 logical positions.

For carriers 14 for which no final destination is known to the routing system 50 the routing system 50 will assign an infinite reservation time to the node of the logical position of such a carrier. Infinite reservation time means that the node cannot be used for further routing until the carrier on that node gets a new final destination again or is removed from the transport plane 12.

The final destination positions of the carriers 14 can be determined by an order management system 60, which gets its order, e.g., from a higher level order management system 70, e.g., a Laboratory Information System in case of a diagnostic laboratory transport system (see FIG. 7 and below). This order management system 60 would then forward the required final destination position for the carriers 14 towards the control system 20 and/or the routing system 50. Mainly the final destination position on the transport plane 12 are determined by the needs of the object 16 to be transported by the carriers 14.

In another embodiment the order management system 60 only defines an identifier of, e.g., the analyzer and the control system 20 translates this into a position for the the routing system 50.

It is also possible that a station 18 requires a specific object 16 or an empty carrier 14 to be loaded and a station control system can send a request to the order management system 60 or the laboratory information system, so that a carrier 14 gets a new final destination.

Usually the laboratory information system realizes a workflow of the stations 18 to which the objects have to be sent, such that the objects 16 are for instance equally distributed to the possible stations 18 and the objects can be processed by the right stations, according to the information obtained from the high level order management 70. In a further embodiment the high level order management 70 is an intermediate software layer often called middleware. The order management system 60 translates this information into destination positions on the transport plane 12 and provides a final destination position assignment for the carriers 14, meaning their respective final destination positions. In further embodiments the distribution of empty carriers 14 to transport objects 16 from the stations 18 after processing are organized at the control system 20 level or the order management 60 level.

In a further embodiment the empty carriers are provided in just in time if required to the stations 18 to their respective final destination positions.

The transport plane 12 comprises sensors to detect status information of the transport system. For instance, the position of the carriers, unavailable or broken positions/nodes on the transport plane, or dirt on the transport plane can be detected by a camera system 21 and appropriate image processing. Other position sensing systems such as Hall-Sensors, current sensors, conductive sensors, capacitive sensors, inductive sensors, or optical barriers are also possible.

In other embodiments only the position of the carrier 14 is sensed by the transport plane 12. If it takes too long (time out) before the carrier 14 arrives at the next logical position, the firmware tries to move it again. After several tries it stops and raises an error. So the related positions is marked as “broken” by the control system. For instance the carrier 14 should move from position 1 via 2 to 3, but did not arrive at 3 and it was sensed it passing 2, the system concludes that the carrier 14 got stuck between 2 and 3. So the control system 20 marks positions 2, 3 and all positions on a straight line in between (and evt. its surrounding positions) as unavailable.

This status information is forwarded to the routing system 50, which stores this status information in a storing device such as a semiconductor memory. The routing system 50 compares the newly received status information with the latest status information stored in the memory device. If a change of status is detected, e.g., some areas on the transport plane are broken, or dirty, or a broken carrier 14 blocks a logical position and if necessary or meaningful also neighboring logical positions. The routing system 50 calculates new routes for the affected carriers 14 by keeping the final destination positions of the carriers 14. It also can appear that a hand over position or handling position, i.e., a final destination position is not available anymore, for instance because the corresponding station 18 stopped working. This station 18 sends this information to the order management system 60 the LIS or to the higher-level order management system 70 in between. The routing system 50 blocks the respective final destination positions as no longer available. This is also a change in the status of the transport plane 12.

The routing system 50 calculates subsequent moves of the carriers 14 before the carriers 14 have reached their intermediate or final destination position assuming that all carriers 14 reach their intermediate or final destination position. The next move is executed without waiting for the routing system 50 calculating the next routes. This makes the routing of the carriers 14 faster.

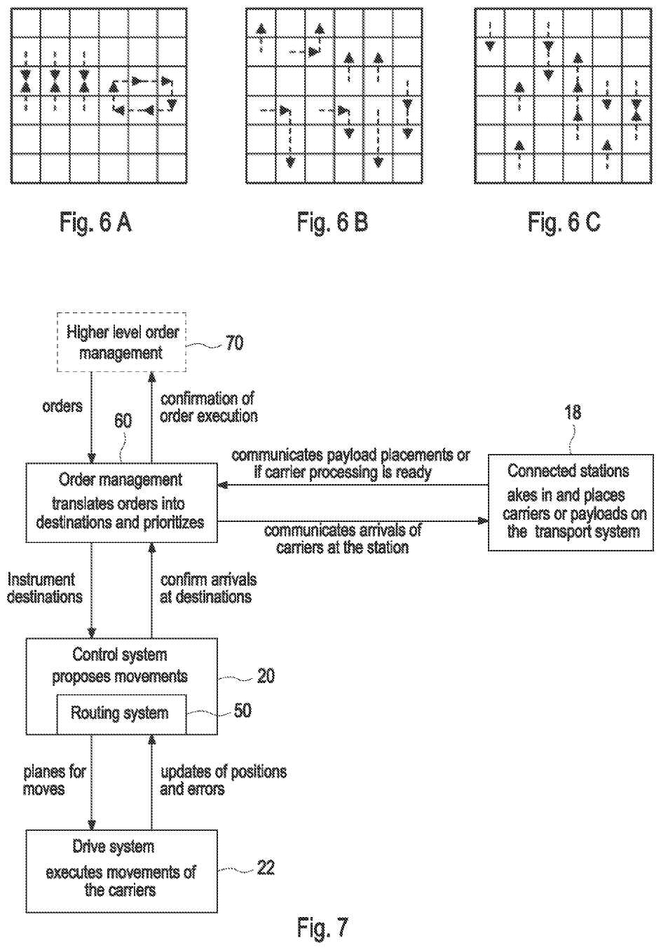

The routing system 50 checks whether the carriers arrive at their stop position after each move based on the planning model. In FIGS. 6A, 6B, and 6C, examples of moves of carriers are shown that will cause running into a dead-lock situation. At the left hand side of FIG. 6A a dead-lock situation is shown due to the fact that 2 opposite moves of carriers block each other. At the right hand side of FIG. 6A a circular dependency has occurred, such that the moves of the carriers mutually block each other.

In FIG. 6B the dead-lock resolving method of using random moves is shown: the carriers are moved into random directions, such that the dead-locking dependencies of FIG. 6A are broken. After this, a normal routing plan is created again, shown in FIG. 6C that enables the carriers to move forward again.

In FIG. 1 the routing system 50 uses some nodes only as final destination for the next planned move. For instance, nodes N1 and N7 will not be used as intermediate destination during cooperative search. Since these nodes are hand over positions to or from the instruments 18, the positions N1 and N7 shall not be blocked by carriers that do not need to be processed by these instruments. Blocking these positions unnecessarily, would be disadvantageous for the throughput of these instruments.

The dotted lines in FIG. 1 divides the transport plane 12 into four logical subareas 24. The routing system 50 allows only a limited number of simultaneous moves of carriers within a logical subarea 24 of the transport plane 12. For instance, the routing system 50 counts the start of moves within the logical subarea 24 and did not plan any further moves for this logical subarea 24 to limit the number of simultaneous moves. The maximal number of simultaneous moves can be fixed for the whole system or be defined per area. For example maximum 8 carriers are allowed to move simultaneously per transport tile or software-defined area. The number of maximum allowed simultaneous moves can also be related to the number of logical positions in that area. For instance, the maximum allowed simultaneous moves in logical subarea 24, e.g., can be in the range of 1% to 70% or 5% to 50% or 10% to 30% or 15% to 25% of the number of available logical positions in the logical subarea 24. This will limit the maximum power draw peaks for that area, such that less or smaller power supplies can be used or to protect electronic circuitry against fast ageing or damaging.

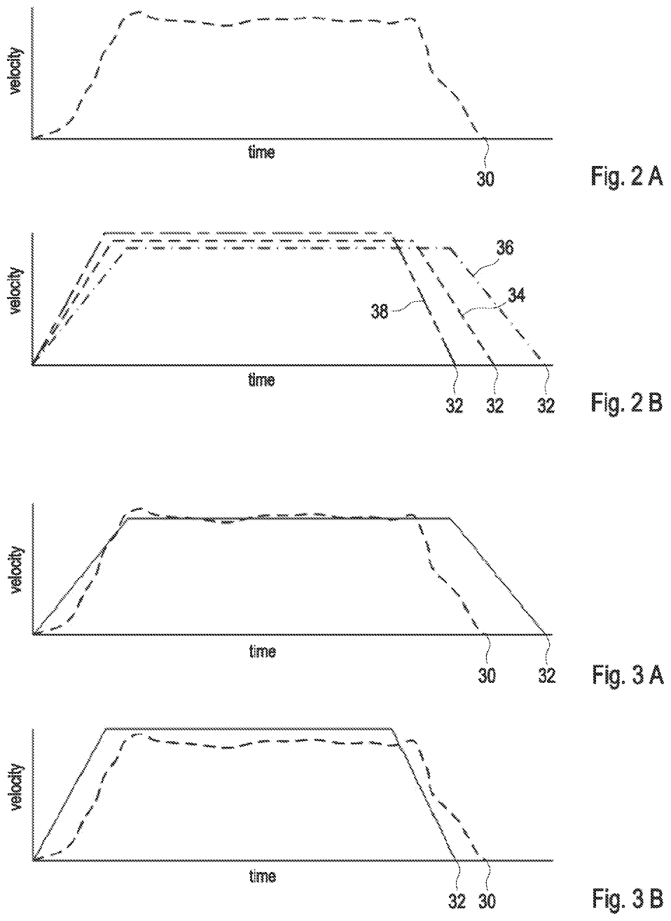

To model the moves of the carriers on the transport plane 12 the routing system 50 uses a planning model. FIG. 2A shows a velocity time diagram of a move of a carrier 14. The acceleration, plateau velocity movement and deceleration may not be constant and completely reproducible due to friction and different environmental conditions on the transport plane 12, disturbances in the drive system due to dust, dirt or varying material friction, transitions between separate modules (e.g., slight gap or height step), -or other effects. The carrier 14 will arrive at its intermediate or final destination position at the real arrival time 30. FIG. 2A shows a real velocity profile of the carrier over time. Each carrier may have a slightly different profile for each move. FIG. 2B shows three planning models with different parameters for acceleration, deceleration and maximum reached velocity. The different planning models will result in different planned arrival times 32.

The dashed line 34 represents a realistic model wherein its planned arrival time 32 closely resembles the real arrival time 30 of FIG. 2A. The dash-dotted line 36 represents a conservative planning model. The planned arrival time 32 is much later than the real arrival time 30 in FIG. 3A. The unequally dashed line 38 represents an over optimistic planning model. The planned arrival time 32 is much earlier than the real arrival time 30 in FIG. 3B. The planning models comprise parameters for acceleration, deceleration and maximum velocity. More complex parametrizations are possible, e.g., dividing the acceleration and deceleration into time intervals with different acceleration and deceleration values or taking the displacement derivatives than acceleration into account. Specifically, FIG. 2B shows the velocity profiles of different models. Model 36 is conservative (assuming lower speeds and accelerations), model 34 fits quite well, model 38 is too optimistic. Plans created with model 38 will fail too often, such that the plans will have to be adjusted if a new update becomes available from the hardware. Plans created with model 36 will succeed, though some performance may be lost due to unnecessary long reserved times.

FIGS. 3A and 3B show two choices of planning models with solid lines compared to the real movement as dashed lines in a velocity time diagram. In FIG. 3A the conservative model assumes a planned arrival time 32 later than the real arrival time 30 after a move. In FIG. 3B a too optimistic model provides a planned arrival 32 earlier than the real arrival time 30. Thus, the plan of 3B will fail because the real arrival time of the move is later than planned.

A good choice of the planning model represents realistically the real movement. The planned arrival time 32 needs to be equal or later than the real arrival time. However due to stochastic variations of the move times, a conservative model is required to avoid failing of too many plans. Otherwise, the carrier 14 will not reach its intermediate or final destination position during the time for the planned reservation duration. This would require a shift in the time plan for the carrier that did not arrive within the planned time window and a replanning of affected other carriers, which leads to a less efficient routing algorithm. If replanning is required frequently, it additionally means a much higher computation power consumption for the router.

In one embodiment the routing system 50 adapts the planning model if the number of failed plans, exceeds a predetermined number, also denoted as threshold. The predetermined number can be an absolute number such as 5, 10 or 100 within a defined time interval, or a ratio of the failed plans to the made plans, e.g., in the range of 5% to 50% failed or 10% to 25% failed or 1% to 10% failed in a time interval.

The time interval can be, e.g., the time required to move a carrier for the maximum reservation length or a predetermined fixed time in the order of minutes, hours or days.

In another embodiment adapting the model to increase the time of move does not necessarily be done in 1 step. The real move times is measured and the model plan is updated (time increased) by the percentage of mismatch between the old modelled move time and measured move time. In particular the model can adapt the planning model to increase the time of a move with a small fix incremental percentage steps—check a number of moves—and increase more until no plans fail anymore during a defined period or number of moves.

In a further embodiment, the routing system 50 adapts the planning models to faster moves in predetermined steps if 100% of the planned moves reach their intermediate or final destination.

For instance, in another embodiment the routing system 50 adapts the parameters for the planning model depending on the fraction of carriers, which reach their intermediate or final destination position in time.

This means the routing system 50 compares the planned moves with the reached stop position of the carriers 14. If the carrier does not reach their planned stop or intermediate or final destination position within the planned reservation time window in, e.g., 5% to 10% or 10% to 25% of all planned moves, the routing system 50 will use a decreased maximum speed or acceleration/deceleration in the planning model. If 90% to 100% of all planned moves reach their planned destination, the routing system 50 will use an increased reachable speed in the planning model.

Another possibility would be that the routing system 50 or control system 20 is configured to measure or calculate the deviation between the modelled and real move times and adjust the planning model using this information, respectively.

Ideally, there are no failed plans. Therefore, ideally the system looks at the real move times and adjusts the model such that the modelled move times equal the real move times plus a small positive delta time. In another embodiment, the routing system changes the planning model stepwise in becoming more optimistic until plans start to fail, and take the last setting with 100% success before the plans started to fail. By measuring the delta time between the time for a real move and the modelled time for many moves, the model or lookup table can be adjusted to provide more accurate but not too early arrival times for the moves.

The routing system 50 can assign and adapt the planning models for individual carriers 14 and also for logical or hardware based subareas 24 of the transport plane 12.

In another embodiment the routing system 50 counts and registers the number of failed plans for each carrier and if the number of failed plans exceeds a predefined number, e.g., in the range of 20 to 100 the routing system 50 marks the failed carrier as maintenance needed and routes the failed carrier to an area where the failed carrier is accessible by an operator or can be sorted out and removed from the transport plane 12. Also the carriers that have exceeded the threshold for failed plans can be flagged by the routing system 50 to be used with low priority in comparison to other available carriers 14 by the control system 20 or order management system 60. Instead of flagging after a certain threshold of failed plans have been reached, the control system 20 or the order management system 60 for the transport system can also prioritize the use of carriers with lower number of failed plans over carriers with a higher number of failed plans.

In a further embodiment the routing system 50 counts the number of failed planned moves within a logical subarea and flags this area as “maintenance needed” when, e.g., 20% to 50% or 5% to 25% or 1% to 5% of the planned moves failed. In a still further embodiment this flagging can be shown to an operator via a user interface informing him that maintenance is required and which transport modules or areas need to be serviced. Alternatively the routing model is adapted to this area only so that a reserved time is increased for a move, in the area where plans have failed.

In another embodiment the routing system 50 allocates a used cost to a node depending on how often a carrier started stopped and moved over this node. For instance, start can give a cost of 2, moving over a cost of 1 and stopping a cost of 3 to the node to indicate the impact of each of the actions on the wear of the surface. The routing system 50 considers in its plans not only the distance cost, as usual for search algorithms, but also the moving over, starting and stopping cost to minimize the overall cost for each planned move. The effect of this cost function for wear will be a better-balanced wear load over the surface, resulting in a longer lifetime of the transport surface and better reliability.

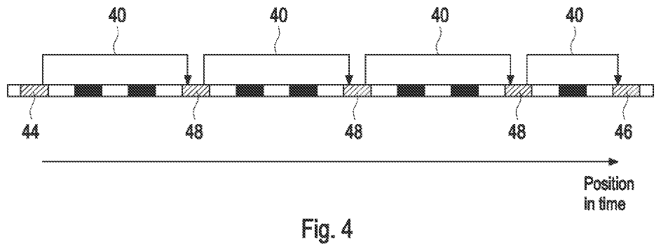

In a further embodiment the routing system 50 uses reservation length such that the start and intermediate or final destination positions of the carriers 14 on the transport plane are possibly equally distributed over the logical positions on the transport plane 12. FIGS. 4A, 4B, 4C show three different possibilities how to move a carrier 14 from a start position 44 to a final destination position 46 with several intermediate destinations positions 48 for a transport system with few carriers 14 such that the maximum reservation lengths can be used for each move. The used positions are presented as hashed, white or black rectangles. The hashed positions are the positions at which the carrier starts or stops.

In FIG. 4 always a maximum reservation length 40 is used until the last move to reach the final destination position 46. Due to this, the hashed positions of a system will statistically be used more often for stop and start of the carriers 14 than others. Consequently, these hashed positions will wear down faster than the black positions. Moves with maximum reservation lengths are very common in areas where there is hardly any crossing traffic. As a consequence, in these areas patterns will occur of increased wear at logical positions positioned at a distance from each other equal to the maximum reservation length.

In one embodiment the routing system is configured to allocate a used-cost to a logical position depending on how often a carrier moved over, started or stopped on this logical position and minimize the used-cost for each planned move. So the patterns of increased wear can be avoided and a more distributed wear can be achieved.

FIG. 7 represents one possible embodiment of the interaction of the different software modules and hardware components. A higher level order management system 70 transfers orders and gets confirmation of order execution to and from an order management system 60. The higher level order management system 70 can be a middleware software or a Laboratory Information System (LIS).

The order management system 60 communicates arrivals of carriers at the stations 18 and gets necessary information of the stations such as, e.g., payload placements or if carrier processing is ready/available from the stations 18. The order management system 60 assigns an object 16 to the carriers and translates a middleware/LIS/high level order management task into a task to transport the related carrier to a position of stations 18 to process the objects 16 transported by the carriers 14.

The order management system 60 communicates instrument destinations to the control system 20 and gets confirmation of arrivals at final destinations from the control system 20. The routing system 50 is here shown for this embodiment as part of the control system and proposes moves and routes to the control system 20. The control system 20 forward the plans for moves to the drive system 22 and receives status updates of the drive system 22 such as updates of positions and errors. The drive system 22 moves the carriers 14 on the transport plane 12.

The building parts Order Management system 60 and Control System 20 are not necessarily different computers. In fact also the Higher Level order management 70 and or LIS can run on the same mainframe. Also, the Order Management system 60 and Control System 20, which can include the routing system 50 can be one software. For example these different software modules can be monolithically integrated or be separate services communicating with each other via a software bus on the same computer.

In further embodiments also other arrangements are possible. For instance, the routing system 50 can be incorporated in the control system 20 and in another embodiment also the control system 20 can be part of the transport table 12.

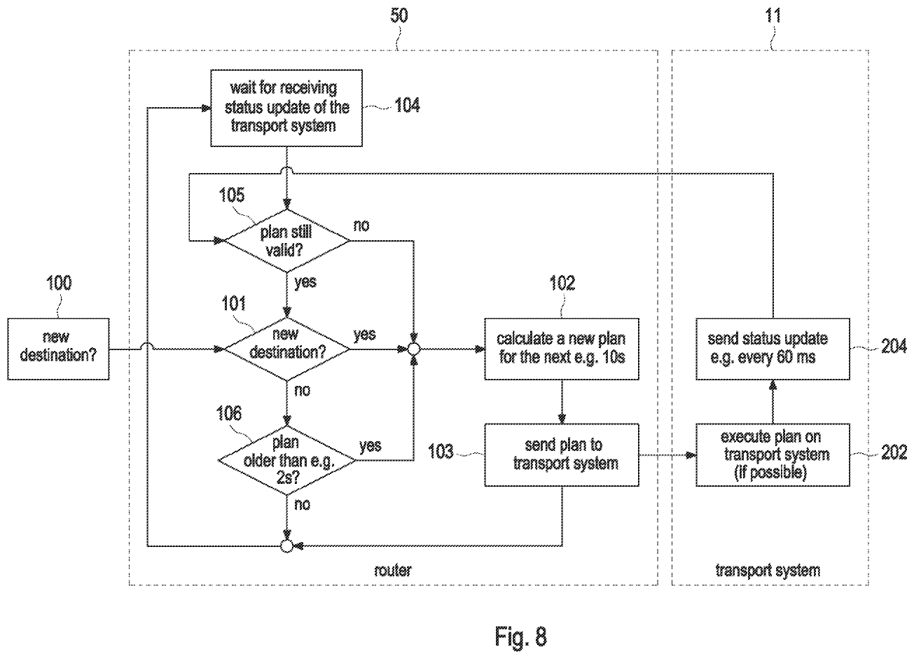

FIG. 8 represents a flow diagram for a routing system 50 of tube carriers in a diagnostics laboratory on a two dimensional transport plane 12.

In a start step 100 the routing system gets a final destination position for a carrier 14 usually from the order management system 60. In a new destination check step 101 the routing system checks whether the destination is new. If the destination is new, with this information the routing system 50 calculates in a routing step 102 n-moves on logical positions with the required free time windows, e.g., n=5, which start within time T, e.g., 10 seconds, using an A* algorithm towards the final destination position on the logical positions with free time windows.

In one embodiment the heuristic is based on the shortest distance to the final destination or on the shortest time to travel to the final destination ignoring other carriers on the transport plane.

Each planned move of the n-moves has a reservation length of k logical positions below or equal to a maximum reservation length of, e.g., 6 logical positions and larger or equal 1.

In the next send step 103 the routing system 50 sends the plan for the moves to the transport system, e.g., the drive system of the transport plane 12.

While the transport system 11 of the distribution system 10 executes the moves of the carriers 14 in an execution step 202 on the transport plane 12 the routing system waits for receiving a status update of the transport system in a “wait” step 104. The transport system sends a status update in a send status step 204, e.g., every 60 ms to the routing system. The time interval between the status messages does not need to be constant. This also includes the status of the carriers, e.g., whether they reached their planned stop or destination position or intermediate destination position. The routing system will compare the status of the transport system with the latest stored status to check whether the plans are still valid in a check step 105. If the “check” step 105 detects that the move is not possible, meaning that the plan failed, the routing system goes back to the routing step 102 to calculate again n moves for the time T.

If the moves are still possible the routing system 50 will check again if a new destination is available in the destination check step 101. If there is a new destination available the routing system 50 will go to the routing step 102 to plan a new route.

If no new destination is available the routing system will check in a check plan age step 106 whether the plan is older than a set time duration, e.g., 2 sec. If the plan is older than the set time duration the routing system will calculate a new plan hence route for the next time window, e.g., for 10 sec in the routing step 102. If not, the routing system will wait for a status update in the wait step 104 and so forth.

FIGS. 9A, 9B, and 9C illustrate possible embodiments of reserved logical positions releases. One or more previously crossed reserved logical positions are released. The borders of the areas are marked as solid black logical positions. In FIG. 9A six modules are connected to each other and the reserved logical positions are released when the carrier crosses the border between the modules. A carrier moves from a starting point to a final destination T. When the carrier has left a black logical position from a first transport module to pass a black logical position of a next transport module, indicated with B! the logical positions reserved for this move on the first transport module are released. As reserved logical positions can also be released after an end of move, indicated with M! and if the final destination position is reached, indicated with T!.

For example, all positions for a move may remain reserved as long as the complete move will take. For example, positions may be reserved for as long as the move will last in a certain logical area. For example, positions may also be reserved until that position is passed by the carrier. For example, positions may be released as soon as each logical position is passed. For example, positions may be released in case a border of a block of logical positions is passed.

FIG. 9B shows the same transport system layout but the areas to release reserved logical positions are defined not via module borders but area borders are defined by marking positions in the software. The release is triggered by a message by passing defined areas. Once the border of an area is passed and another area is entered, indicated with A! the reserved logical positions of this move in the left area are released.

FIG. 9C shows a direct release where a logical position release message is sent each time when a logical position is passed. So each logical position on the route defines its own release area.

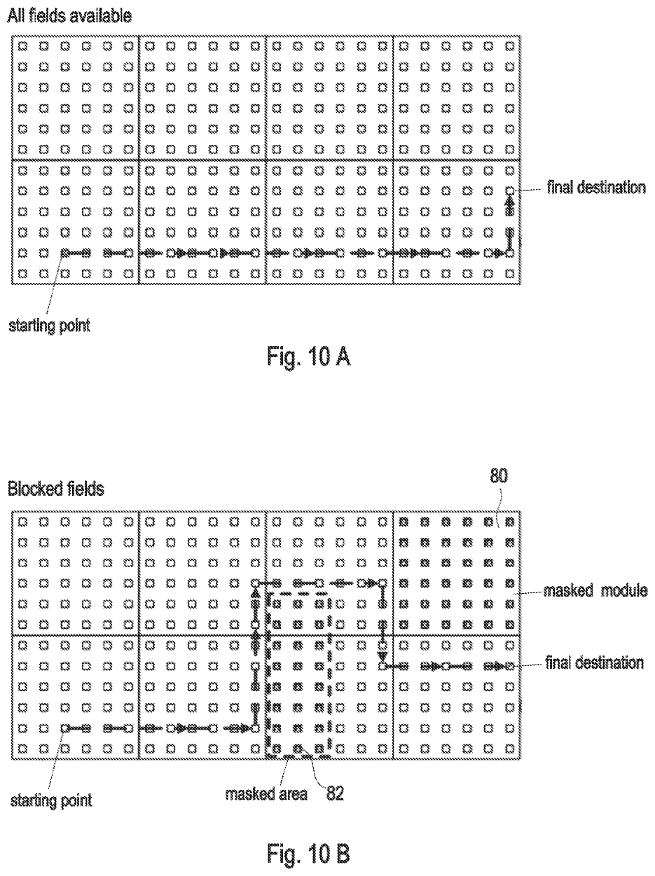

FIGS. 10A and 10B illustrates the effect if logical positions are masked, e.g., when fields or a module is broken. Both FIG. 10A and FIG. 10B show the same layout of a transport plane 12 with 2 times 4 modules. Each move of the carrier is illustrated by an arrow.

FIG. 10A shows the availability of all logical positions. A route of 6 moves with different amounts of logical positions per move from a starting point to a final destination is shown, whereas FIG. 10B shows a situation where, e.g., a complete right upper module 80 needs to be exchanged and an area 82 of 3×8 logical positions is masked as well for transport. The routing system 50 will take into account the unavailability of the X-marked positions, e.g., by putting infinite reservation times on them or by updating the positions layout and trying to calculate a route over the available logical positions. This results in a route of 8 moves from the same starting point to the same final destination point as in FIG. 10A.

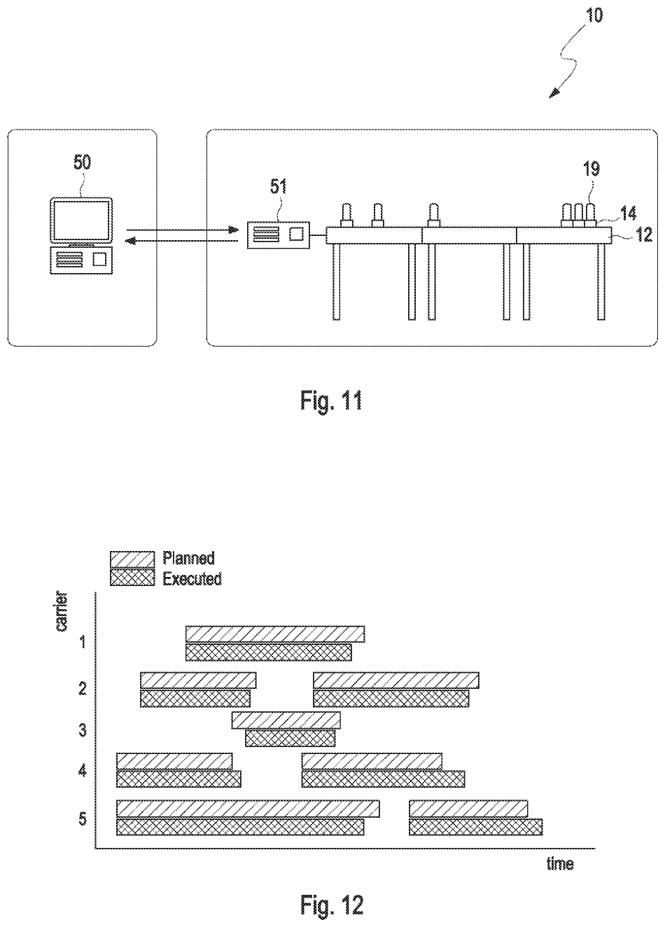

FIG. 11 shows an embodiment of a distribution system 10. The distribution system 10 comprises the routing system 50 and an executing unit 51. Although the routing algorithms used for planning the routes of the carrier 14 on the transport plane 12 for transporting, e.g., payloads 19 may physically be deployed in the same computer, this split between routing system 50 and executing unit 51 may allow that the routing system 50 only proposes moves. The executing unit 51 tries to execute the planned routes, but due to stochastic effects, exceptions and errors, not all plans may be executed as defined.

FIG. 12 depicts a Gantt diagram which shows an example of the times carriers denoted with numbers 1 to 5 are moving (executed) versus the planned times. As long as the execution times are within the planned time ranges, the planned route can be executed. If not, a move exceeds the planned time, potentially violating other planned moves and resulting in failed plans. From top to bottom, carriers 1 and 2 show embodiments of succeeded execution of the plan. Carrier 3 shows that although a move may be started later than planned, e.g., because another carrier was delayed, it may happen that the carrier still arrives in time, such that the plan was successfully executed. Carrier 4 shows two delayed arrivals and carrier 5 that the last arrival is delayed.

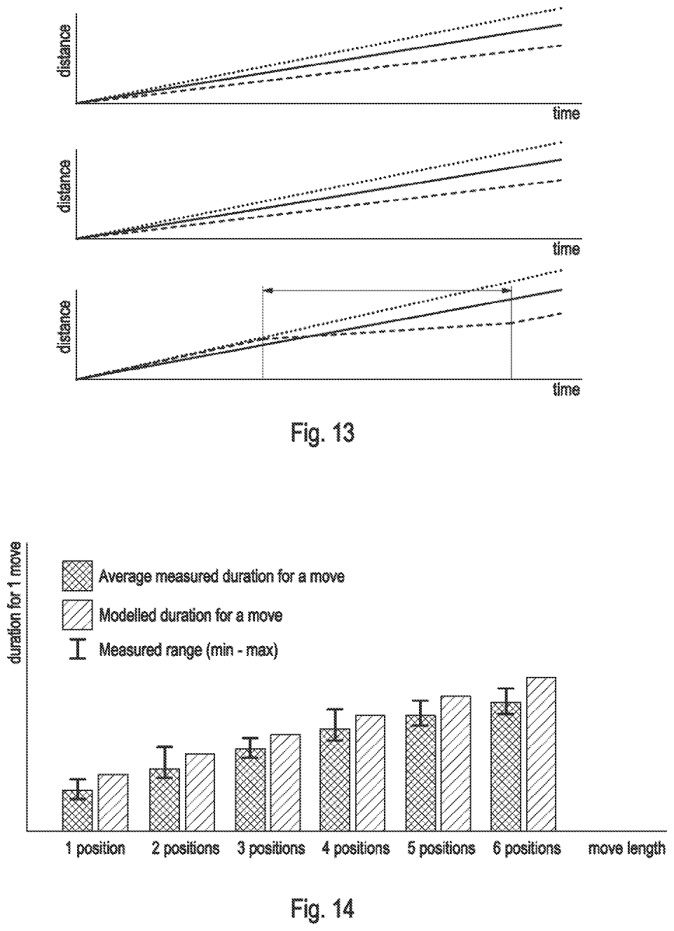

FIG. 13 shows stochastic effects of movement in routing. Transport methods, like where carriers 14 are driven by a combination of electromagnetic forces and friction, show stochasticity. Friction forces between sliding surfaces in general can be a rather varying factor. Additionally, surfaces of carriers and the transport sliding surface may not be uniform over the full surface. The roughness may vary over a transport surface of the transport plane 12, for instance due to differences in wear, material inhomogeneities, dirt or dust or moisture etc. Also some module surface plates may have been renewed more recently than others and therefore show a different friction level than older plates. The same will be the case for the contact surface of the carrier with the transport surface. As a consequence of these varying friction forces, the time a move takes has an unpredictable, stochastic component as well. If friction is higher than average friction, the carrier will accelerate slower and may not reach the same plateau speed. Also, it will cause the carrier to decelerate faster. The executing unit that controls the moves will try to regulate this, but still a variation in acceleration and speed profiles will be shown for the moves and carriers 14. In the FIG. 13, examples of impact stochastic effects are shown: the upper figure shows the effect of different friction levels of the carriers in a simplified way; for a carrier 1 having low friction (dotted line), for a model considering moderate friction (solid line), for a carrier 2 having high friction (dashed line). The lines show the travelling distance for carriers moving with a constant speed. Realistically these are not straight lines but can show rather random variations of which the average speed resembles these lines in a simplified way. If a carrier 1 has a lower friction than the deterministic model assumes, it will travel faster and therefore do its moves faster than the more pessimistic model of a carrier 2 that shows more friction. The same can happen for different transport surfaces, as shown in the middle figure. The figure in the middle shows the corresponding effect for a carrier on a low friction transport surface (dotted line), for a model considering moderate friction (solid line), for a carrier on a high friction transport surface (dashed line). The bottom figure show an embodiment of local friction differences on the transport surface; a carrier travelling over a transport surface with constant friction is shown in dotted lines, a model assuming constant friction is shown as a solid line and a carrier, e.g., carrier 2, travelling over a transport surface with a local area with a higher friction is shown as a dashed line. In particular, the bottom figure shows the effect of carriers travelling over a distance with a constant friction, the more pessimistic deterministic model, assuming a lower speed and the situation where the carrier travels over distance, where the first and last part has the same friction but the area in between shows a higher friction and therefore lower average speed of the carrier.

FIG. 14 shows consequences of stochastic effects for moves. The consequence of the stochasticity is that it will cause variations of the durations for the moves. FIG. 14 gives an example of what could happen: the deterministic model assumes durations for the different move lengths. Here the maximum move length (max reservation length) is assumed to be 6. During many measurements the values could look like shown by the light grey bars: the average durations for moves are shorter than the model assumes. However, for moves with 2 and 4 positions, some moves took longer than the modelled durations. Hence, for these moves the plans will fail as the arrival time at the end position of the moves were later than planned.

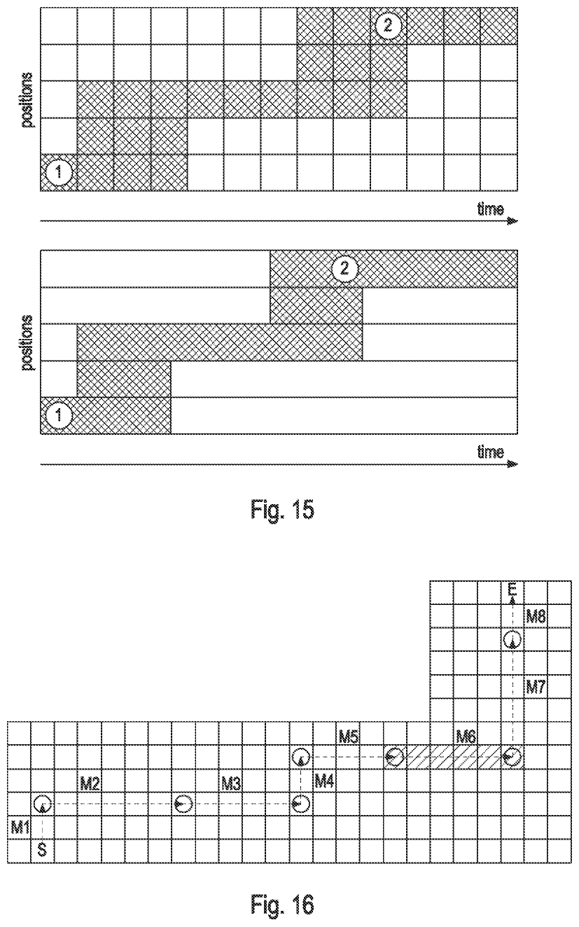

FIG. 15 shows discrete time WHCA* algorithms in gaming as described, e.g., in B. Zahy et al., “Conflict-Oriented Windowed Hierarchical Cooperative A”, 2014 IEEE International Conference on Robotics and Automation (ICRA), IEEE, May 31, 2014, pages 3743-3748, XP03265061 8, DOI: 10.1 109/ICRA.2014.6907401 vs continuous WHCA* algorithm as proposed according to the present disclosure.

In gaming the durations of events are usually discretized whereas the present disclosure proposes using continuous times. In gaming the discrete time step is typically related to the frame rate of the game. For the routing system according to the present disclosure there may be no need using discrete time steps. Continuous time durations may allow the routing algorithm to be more efficient as the moves can start at any time. FIG. 15 explains the difference between discrete time and space for games and discrete space but continuous time for this present disclosure. On the horizontal axis the time is shown and in the vertical axis the logical positions that are reserved (grey) or free (white) at each time. If a carrier moves from the position 1 to 2, the routing method with discrete times may reduce the speed as each reservation plan has to fit the discrete time steps. In contrast thereto, if arbitrary times can be used, the next plan can be made to fit the movements model without having to take the discrete time steps into account.

In gaming, the gaming engine generates its events. This means that all events are self-defined and therefore predictable. However, in the technical field of distribution systems for carriers for transporting the objects, the real world has to be considered. The real world may have unpredictable elements like the stochastic effects in the movements, orders for new moves may come in unexpectedly, instruments place or may require carriers, exceptions and errors can occur like broken fields, carriers which cannot be moved anymore, areas get temporarily blocked for routing, moves may take much longer than expected or fail entirely etc. The routing system cannot influence these events but needs to be able to react to these events. Thus, the routing system ma in the present disclosure be designed for performing routing in a more robust way such that it can find solutions to solve any unexpected situation. In gaming, unpredictable events may come from the players. However, although these events are unpredictable, it all runs via the gaming engine which generates the routing based on all this “unpredictable” information. This means that for the router in gaming all information is available before routes are created such that the movements of the agents can be executed according to the plans, based on this completely known situation. For the routing system according to the present disclosure the situation is different: the routing system only may receive information about the destinations the carriers will have to be moved to and may updates of succeeded and failed moves and eventually other status information. The routing system cannot control the real-world events but only wait to see which of the plans will succeed or not and when the moves will finish. Hence, in contrast with the gaming engine, the routing system may be designed to be robust to deal with the unexpected.

In the technical field of distribution systems for carriers for transporting the objects, the number of agents, i.e., the carriers for the distribution system, can be over a thousand. For games this is typically much lower. Moreover, the carrier densities can be very high, up to levels where many carriers are blocked by their neighbors such that they cannot make any movements until the traffic density is reduced. For gaming the space the agents can use to move within is typically not as constrained and, as mentioned before, the gaming engine is fully in control and informed of what is happening. Because of this lower interaction between the units, most games (e.g., starcraft 2) do not consider multi-agent pathfinding and instead use variants of A* for single agent pathfinding in combination with some “steering behavior” heuristics which will adjust trajectories slightly if, perchance, two units would cross paths. Thus, the technical field of gaming and of distribution systems for carriers for transporting the objects are very different, have different requirements and therefore, require different and specific solutions.

FIG. 16 illustrates potential moves. “S” may be the starting point of a carrier, at which it was parked until the task came in to move it to the final destination point “E”. The routing system may generate plans for moves. Each move may end at an intermediate destination, indicated with a circle. The routing system may plan a defined amount of time ahead, for instance 10 s. Because of this it may for a first plan only plan the route-part M1 until M3. In subsequent plans the other moves may be planned. Each move may have a length of a certain number of positions, which will be reserved in the time plan. During the execution of the plan the planned positions for the next move may be reserved, as shown by the hatched positions for move M6. The number of positions that can be reserved in the plan, c.q. during the execution of the plan depends on which positions are available (e.g., not occupied at that time by other carriers) and the maximum reservation length. For instance, in this example the maximum reservation length could be 6 positions. Only the position reservations for move M2 may be limited by this maximum reservation length, the other moves are shorter and limited by the availability of positions at the right time, e.g., due other carriers (not shown in this drawing). The other traffic could also be the reason why the carrier changes direction for move M4, e.g., because another carrier blocked the possibility to continue moving in a straight line.

The time it takes to complete the transport from “S” to “E” may depend on the time each move takes and the waiting times at the intermediate destination points, indicated with circles. The move times may depend on the move length (number of positions for each move) as well as the speed profile (accelerations, plateau velocities, decelerations). The velocities, accelerations and decelerations can be the same for each move at any time (deterministic), but the presented disclosure is especially suitable to handle stochastic variations of the speeds, accelerations and decelerations as well. Thus, moves with equal move lengths may take different durations.

### REFERENCE NUMBERS

1 module 1
2 module 2
3 module 3
4 first move
5 second move
6 third move
7 second router
8 crossing route
10 distribution system
11 transport system
12 transport plane
13 first reservation table
14 carrier
15 second reservation table
16 object
18 station
19 payloads
20 control system
21 camera system
24 logical subarea
25 first move of second route
26 second move of second route
27 third move of second route
30 real arrival time
32 planned arrival time
34 interrupted line
36 dotted line
38 unequal interrupted line
40 maximum reservation length
42 variable reservation length
44 start position
46 final destination
48 intermediate destination
50 routing system
51 executing unit
60 order management system
70 higher order management system
80 upper right module
82 area
100 start step
101 destination check step
102 routing step
103 send step
104 wait step
105 check step
106 check plan age step
202 execution step
204 send status step

What is claimed is:

1. A distribution system comprising:
a transport plane comprising logical positions for distributing objects,
carriers for transporting the objects,
a drive system to move the carriers on the transport plane between the logical positions,
a control system configured to control the carriers to move on a planned route from a start position to a final destination position on the transport plane,
wherein the control system comprises a routing system configured to calculate the planned route for at least two carriers on the transport plane by modeling the transport plane with graphs of nodes and using a windowed hierarchical cooperative informed search algorithm within cooperative time window T, wherein the windowed hierarchical cooperative informed search algorithm is a windowed hierarchical cooperative A* algorithm,
wherein the routing system is configured to determine reserved and free time windows for each logical position,
characterized in that the routing system is configured to assign an individual reservation length to each carrier for the next move on logical positions with free time windows,
wherein an infinite reservation time is assigned to a logical position on the transport plane,
wherein the control system comprises at least one executing unit configured for executing the planned routes for transporting the carriers from their respective start position to their respective final position.

2. The distribution system according to claim 1, wherein the routing system is configured to assign an infinite reservation time to the logical position if one or more of the following is realized:
the logical position is the position of a carrier without a final destination,
the logical position is considered as broken or blocked,
during the cooperative time window T no possibility is found to move the carrier from the logical position.

3. The distribution system according to claim 1, wherein the routing system is configured to use the most reservation length available for a straight move.

4. The distribution system according to claim 3, wherein the most reservation length available for a straight move is below a determined maximum reservation length.

5. The distribution system according to claim 1, wherein the routing system is configured to receive status information of the transport system.

6. The distribution system according to claim 5, wherein the routing system is configured to compare the status information with the latest status information stored in the routing system.

7. The distribution system according to claim 6, wherein when a change in status is detected by the comparison new planned routes with new reservation lengths are calculated for the next moves.

8. The distribution system according to claim 1, wherein the routing system is configured to determine subsequent planned routes after the current move assuming that each move will succeed.

9. The distribution system according to claim 1, wherein the routing system is configured to check whether all carriers arrive within a planned reservation length and when carriers are detected which will not arrive within the planned reservation length the next planned reservation length will be stretched and affected plans of other carriers are recomputed.

10. The distribution system according to claim 1, wherein the routing system is configured to allow at least one of the logical positions to be only addressed as final destination by the carriers and forbidden to be used as intermediate destination position to transport carriers towards their final destination position.

11. The distribution system according to claim 1, wherein the transport plane is divided into logical subareas.

12. The distribution system according to claim 11, wherein the routing system is configured to allow only a limited number of simultaneous moves of carriers within logical subareas of the transport plane.

13. The distribution system according to claim 1, wherein the routing system is configured to release each logical position reserved by the current move after the carrier passed a predefined logical position on the transport plane.

14. The distribution system according to claim 1, wherein the routing system is configured to check the success or failure of the planned move and wherein depending on the number of failed plans the parameters of the planning model are adapted either for the complete transport plane with same values or for the logical subareas with different values or for a carrier on a specific subarea with individual parameters.

15. The distribution system according to claim 1, wherein the routing system is configured to adapt the maximum reservation length depending on the deviation of the planned reservation length with maximum reservation length.

16. The distribution system according to claim 1, wherein the routing system is configured to count the number of failed plans for each carrier and/or subareas of the transport plane and if the number of failed plans exceeds a predefined number or the frequency of failing exceeds a predefined number either the carrier is marked as maintenance needed or the transport plane or the subarea is marked as maintenance needed and/or avoided or used less for further routing.

17. The distribution system according to claim 1, wherein the routing system is configured to allocate a used-cost to a logical position depending on how often a carrier moved over, started or stopped on this logical position and minimize the used-cost for each planned move.

18. The distribution system according to claim 1, wherein the routing system is configured to check whether a dead-lock occurred and in the case a dead-lock is detected for all carriers in the neighborhood of the dead-lock the next n-moves are chosen from possible moves ignoring a metric to the final destination.

19. The distribution system according to claim 18, wherein the next n-moves are chosen randomly.

20. The distribution system according to claim 1, wherein the windowed hierarchical cooperative informed search algorithm is designed for reserving time windows in continuous time and based on at least one realistic time travel model.
